(19) United States
(12) Patent Application Publication
(10) Pub. No.: US 2012/0054751 A1
(43) Pub. Date: Mar. 1, 2012

(54) DISPOSITION DETERMINATION TECHNIQUE

(75) Inventors: Fumi Iikura, Kawasaki (JP); Yasuhide Matsumoto, Kawasaki (JP)

(73) Assignee: FUJITSU LIMITED, Kawasaki-shi (JP)

(21) Appl. No.: 13/107,545

(22) Filed: May 13, 2011

(30) Foreign Application Priority Data
Aug. 25, 2010 (JP) 2010-188588

(51) Int. Cl. G06F 9/46

(52) U.S. Cl. 718/100

(57) ABSTRACT

This method includes: obtaining data of a first cost that represents a communication cost for communication with a processing apparatus that is included in a second system and carries out a processing by an application program for data held in the first system; calculating a second cost that represents a cost that occurs when the application program is disposed in the first system by using data of a charge for use of the application program and data of a cost required for maintenance and operation for an apparatus for carrying out a processing by the application program; determining whether a first condition including a second condition concerning a relationship between the first cost and the second cost is satisfied; and upon detecting that the first condition is satisfied, storing data representing that the first system is a system in which the application program is to be disposed.

### CROSS-REFERENCE TO RELATED APPLICATIONS

This application is based upon and claims the benefit of priority of the prior Japanese Patent Application No. 2010-188588, filed on Aug. 25, 2010, the entire contents of which are incorporated herein by reference.

### FIELD

This technique relates to a technique for determining a system in which an application program or data is to be disposed.

### BACKGROUND

Recently, services called Infrastructure as a Service (IaaS) and/or Software as a Service (SaaS) are spreading. In such services, the user can use the infrastructure (e.g. network, server, storage and the like) provided by the IaaS provider, and/or functions of softwares provided by the SaaS provider through the network such as the Internet. Therefore, it is unnecessary for the user who uses the IaaS and/or SaaS to construct an information system and purchase the application programs themselves.

FIG. 1 illustrates a schematical diagram to explain a state where the user uses IaaS and SaaS. In an example of FIG. 1, by transmitting a request through a system of the IaaS provider, the user can cause the application server in the SaaS provider to carry out a processing for data stored in a storage unit in the IaaS provider.

When such a processing is carried out, data to be processed is transferred between the system of the IaaS provider and the system of the SaaS provider. As for the communication cost, which occurs with the data transfer, there is a case where the user bears the cost according to the data transfer amount, and there is a case where the user bears the fixed amount of money and the service provider bears the rest of the cost. Therefore, the service provider and/or the user may be heavily burdened with the large data transfer amount.

Conventionally, in order to realize the reduction of the communication cost and the distribution of the processing load, there is a technique for dispersively disposing objects (i.e. processing unit including data and a set of methods in which the processing procedure is defined) to plural computers. Specifically, a dispersive disposition daemon refers to information of the communication cost between computers (connection relationship between computers), information of the communication amount between objects (dependence between objects) and load information of each computer to determine the computers in which the objects are to be disposed.

However, actually, the cost that the service provider and/or the user bear is not limited to the aforementioned communication cost. Therefore, even if systems in which data and/or application program are to be disposed are determined only based on the communication cost between the service providers, the cost reduction can not be always achieved.

Namely, it is impossible for the conventional arts to effectively reduce the cost that is born by the service provider that provides the service through the network or by the user that receives the service.

### SUMMARY

A method for determining a disposition destination of an application program relates to a first aspect of this technique and is executed by a computer in a first system. Then, this method includes: (A) obtaining data of a first cost that represents a communication cost for communication with a processing apparatus that is included in a second system and carries out a processing by an application program for data held in the first system; (B) calculating a second cost that represents a cost that occurs when the application program is disposed in the first system by using data of a charge for use of the application program and data of a cost required for maintenance and operation for an apparatus for carrying out a processing by the application program; (C) determining whether a first condition including a second condition concerning a relationship between the first cost and the second cost is satisfied; and (D) upon detecting that the first condition is satisfied, storing data representing that the first system is a system in which the application program is to be disposed.

A method for determining a disposition destination of data relates to a second aspect of this technique and is executed by a computer in a first system. Then, the method includes: (E) obtaining a first communication cost that represents a communication cost that occurs when a second processing apparatus in a second system carries out a processing for a specific data used in a processing by a first processing apparatus in the first system, and obtaining a first storage charge that represents a storage charge that occurs when the specific data is held by the first system to calculate a first charge that represents a charge for a service, which occurs when the specific data is held in the first system, by using the first communication cost and the first storage charge; (F) obtaining a transfer amount of data that is used in a processing by the first processing apparatus and used in a communication with the first processing apparatus among the specific data, from a transfer log storage unit storing transfer logs generated in response to data transfer, to calculate, by using the obtained transfer amount, a second communication cost that represents a communication cost presumed to occur when the first processing apparatus in the first system carries out a processing for the specific data when the specific data is held by the second system; (G) obtaining a second storage charge that represents a storage charge that occurs when the specific data is held by the second system to calculate, by using the second communication cost and the second storage charge, a second charge that represents a charge for a service, which occurs when the specific data is held by the second system; (H) determining whether a first condition including a second condition for a relationship between the first charge and the second charge is satisfied; and (I) upon detecting that the first condition is satisfied, storing data representing that the second system is a system in which the specific data is to be held.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain a presumption of this embodiment;

FIG. 2 is a diagram depicting a system outline relating to a first embodiment;

FIG. 3 is a diagram depicting a configuration of a first system in the first embodiment;

FIG. 4 is a diagram depicting a configuration of a second system in the first embodiment;

FIG. 5 is a diagram depicting an example of data stored in a first cost data storage unit;

FIG. 6 is a diagram depicting an example of data stored in a second cost data storage unit;

FIG. 7 is a diagram depicting a processing flow of a processing relating to the first embodiment;

FIG. 8 is a diagram depicting a system outline relating to a second embodiment;

FIG. 9 is a diagram depicting a configuration of a first system in the second embodiment:

FIG. 10 is a diagram depicting a configuration of a second system in the second embodiment;

FIG. 11 is a diagram depicting an example of data stored in a cost data storage unit;

FIG. 12 is a diagram depicting an example of data stored in a charge data storage unit;

FIG. 13 is a diagram depicting an example of data stored in a transfer log storage unit;

FIG. 14 is a diagram depicting a processing flow of a processing relating to the second embodiment;

FIG. 15 is a diagram depicting a system outline relating to a third embodiment;

FIG. 16 is a functional block diagram of an IaaS providing server in the third embodiment;

FIG. 17 is a diagram depicting an example of data stored in a transfer log storage unit;

FIG. 18 is a diagram depicting an example of data stored in a tabulation storage unit;

FIG. 19 is a diagram depicting an example of data stored in a cost data storage unit;

FIG. 20 is a diagram depicting an example of a service address table in an address list storage unit;

FIG. 21 is a diagram depicting an example of a data address table in the address list storage unit;

FIG. 22 is a diagram depicting an example of a server management table in a resource data storage unit;

FIG. 23 is a diagram depicting an example of a storage management table in a resource data storage unit;

FIG. 24 is a diagram depicting an example of an address management table in the resource data storage unit;

FIG. 25 is a diagram depicting a processing flow of a first evaluation processing;

FIG. 26 is a diagram depicting an example of data included in an application descriptor;

FIG. 27 is a diagram depicting a connection relationship of components;

FIG. 28 is a diagram depicting a processing flow of the first evaluation processing;

FIG. 29 is a diagram depicting an example of a service address table in the address list storage unit;

FIG. 30 is a diagram depicting a processing flow of a processing when a utilization request is received;

FIG. 31 is a diagram depicting a processing flow of a first data processing;

FIG. 32 is a diagram depicting a processing flow of a second data processing;

FIG. 33 is a diagram depicting a processing flow of a first re-evaluation processing;

FIG. 34 is a diagram depicting a system outline relating to a fourth embodiment;

FIG. 35 is a functional block diagram of a resource management server in the fourth embodiment;

FIG. 36 is a diagram depicting an example of data stored in the transfer log storage unit;

FIG. 37 is a diagram depicting an example of data stored in the tabulation storage unit;

FIG. 38 is a diagram depicting an example of data stored in a fee table in an evaluation data storage unit;

FIG. 39 is a diagram depicting an example of data stored in a service level table in the evaluation storage unit;

FIG. 40 is a diagram depicting an example of a service address table in an address list storage unit;

FIG. 41 is a diagram depicting an example of a data address table in the address list storage unit;

FIG. 42 is a diagram depicting an example of data stored in the address list storage unit;

FIG. 43 is a diagram depicting a processing flow of a second evaluation processing;

FIG. 44 is a diagram depicting an example of data stored in the address list storage unit;

FIG. 45 is a diagram depicting a processing flow of a processing carried out when a utilization request is received;

FIG. 46 is a diagram depicting a processing flow of a third data processing;

FIG. 47 is a diagram depicting a processing flow of a fourth data processing;

FIG. 48 is a diagram depicting a processing flow of a second re-evaluation processing; and

FIG. 49 is a functional block diagram of a computer.

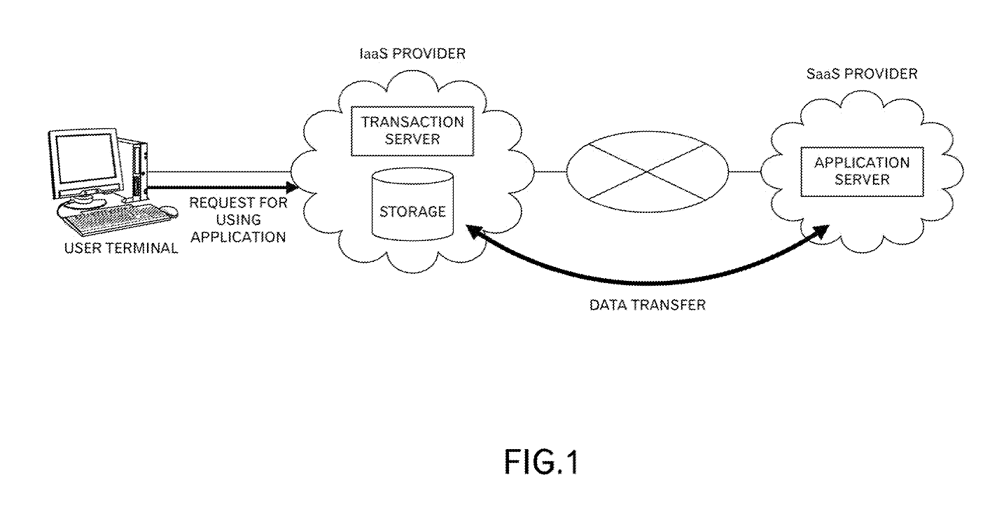

### DESCRIPTION OF EMBODIMENTS

### First Embodiment

First, a first embodiment of this technique is explained. In the first embodiment, a processing for determining a system in which an application program is to be disposed.

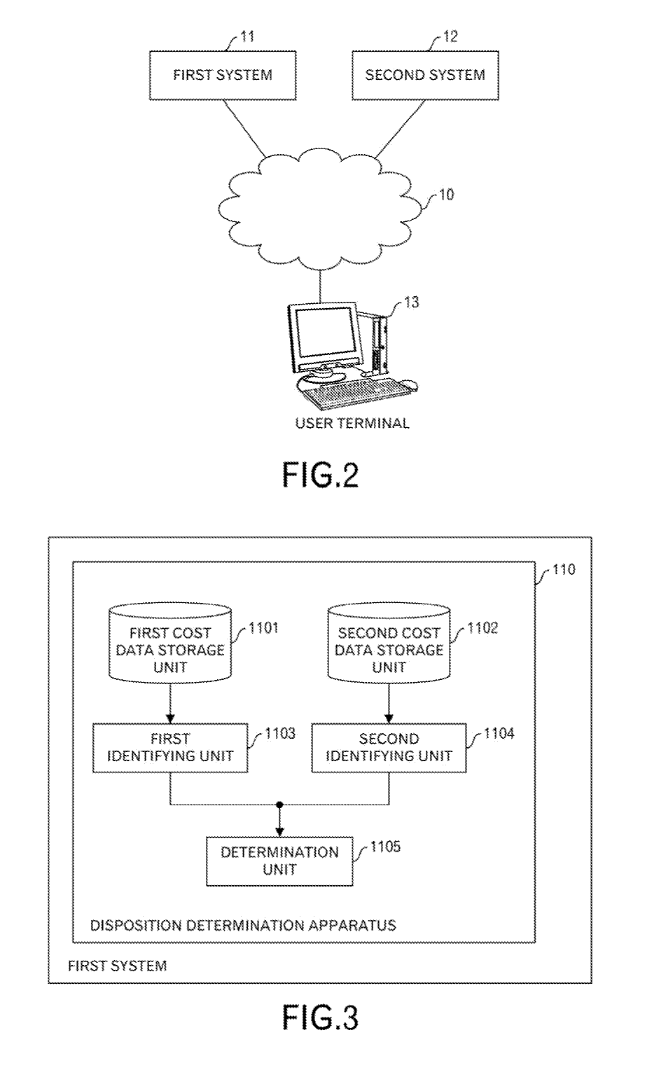

FIG. 2 depicts a system outline diagram relating to the first embodiment. In an example of FIG. 2, a first system 11, second system 12 and user terminal 13 are connected with a network 10 such as the Internet. Incidentally, although only one user terminal 13 is depicted in the example of FIG. 2, the number of terminals is not limited.

FIG. 3 depicts a functional block diagram of the first system 11 depicted in FIG. 2. The first system 11 includes a disposition determination apparatus 110. The disposition determination apparatus 110 includes a first cost data storage unit 1101, second cost data storage unit 1102, first identifying unit 1103, second identifying unit 1104 and determination unit 1105.

The first identifying unit 1103 carries out a processing by using data stored in the first cost data storage unit 1101, and outputs a processing result to the determination unit 1105. The second identifying unit 1104 carries out a processing by using data stored in the second cost data storage unit 1102, and outputs a processing result to the determination unit 1105. The determination unit 1105 carries out a processing for determining a system in which an application program is to be disposed, by using the processing results from the first identifying unit 1103 and second identifying unit 1104.

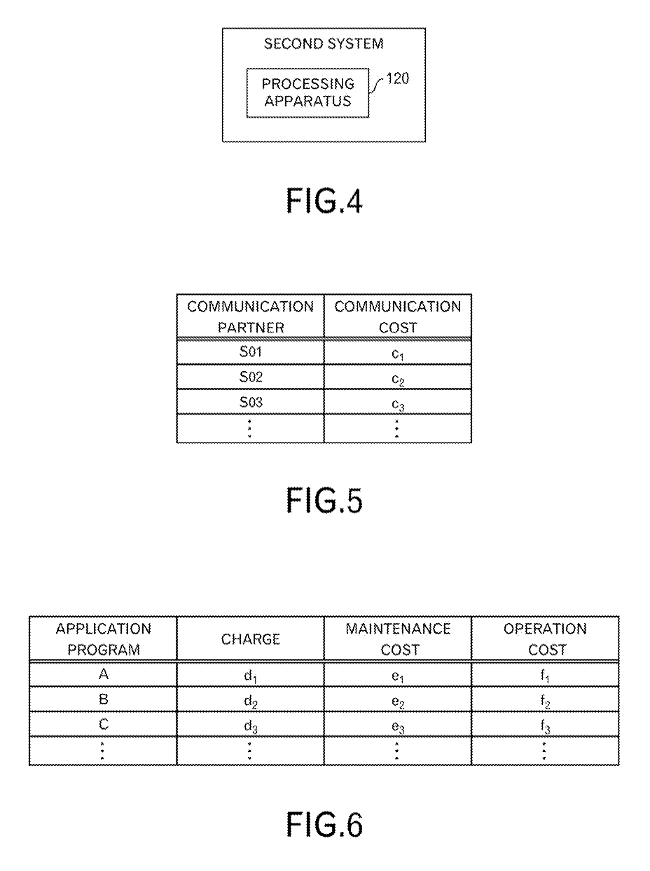

FIG. 4 is a functional block diagram of the second system 12 depicted in FIG. 2. The second system 12 includes a processing apparatus 120. The processing apparatus 120 executes an application program to be considered in this embodiment (hereinafter, referred to a target application program), and carries out a processing for data received from the first system 11.

FIG. 5 depicts an example of data stored in a first cost data storage unit 1101. In an example of FIG. 5, a data structure includes a column of an identifier of a communication partner and column of a communication cost. Incidentally, in the first embodiment, as for the communication cost that is caused by data transfer carried out between the first system and the second system, it is assumed that there is a contract that the user bears a fixed amount of money, and the service provider of the first system bears the rest of the communication cost. Then, data of the communication cost to be born by the service provider of the first system is stored in the first cost data storage unit 1101.

FIG. 6 depicts an example of data stored in the second cost data storage unit 1102. In an example of FIG. 6, a table includes a column of an identifier of an application program, a column of a charge (e.g. license fee), a column of a maintenance cost and a column of an operation cost. Incidentally, the charge and cost are estimated per one month, for example.

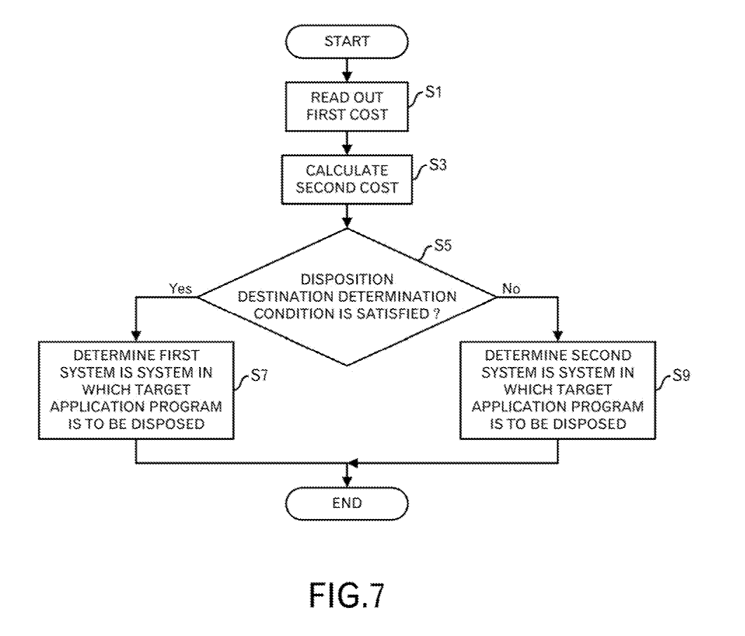

Next, processing contents of the system depicted in FIG. 2 is explained by using FIG. 7. Here, a processing will be explained to evaluate which of the first system 11 and second system 12 is better in view of the cost when the target application program is disposed. Incidentally, this processing is carried out, periodically, (for each month).

First, the first identifying unit 1103 in the disposition determination apparatus 110 reads out a communication cost (hereinafter, called a first cost) between the processing apparatus 120 in the second system 12 and the first system 11 from the first cost data storage unit 1101, and stores the read data into a storage device such as a main memory (FIG. 7: step S1). Incidentally, as for the communication cost, the communication cost, which were monitored, for example, may be employed, and the communication cost calculated based on the data transfer amount may be employed.

In addition, the second identifying unit 1104 reads out the charge for the target application program and the cost required for the maintenance and operation from the second cost data storage unit 1102, and calculates the cost that occurs when the target application program is disposed in the first system 11 (hereinafter, called a second cost), and stores the calculated cost into the storage device, such as the main memory (step S3). The second cost may be calculated by a predetermined function f₁(x, y, z). Here, x represents the charge for the target application program, y represents the maintenance cost and z represents the operation cost.

Then, the determination unit 1105 uses the processing results from the first identifying unit 1103 and second identifying unit 1104 to determine whether or not a disposition destination determination condition including a first condition concerning the relationship between the first cost and the second cost is satisfied (step S5).

The first condition may be a condition that the first cost is simply larger than the second cost or a condition that the first cost is larger than the second cost a predetermined amount (or predetermined ratio). Moreover, a condition that the first cost is larger than the second cost in plural unit periods immediately before or a condition that an average value of the first costs in some months immediately before is greater than an average value of the second costs in some months immediately before may be employed.

Then, when it is determined that the disposition destination determination condition is not satisfied (step S5: No route), the determination unit 1105 determines that the second system 12 is a system in which the target application program is to be disposed, and stores data representing the second system 12 is determined as the disposition destination into the storage unit such as the main memory (step S9). This is because it is better in view of the cost that the target application program is still disposed in the second system 12.

On the other hand, when it is determined that the disposition destination determination condition is satisfied (step S5: Yes route), the determination unit 1105 determines that the first system 11 is a system in which the target application program is to be disposed, and stores data representing that the first system 11 is determined as the disposition destination into the storage unit such as the main memory (step S7). This is because it is better in view of the cost that the target application program is disposed in the first system 11. Then, after the step S7, data stored in the storage unit such as the main memory is transmitted to a terminal of an administrator in the service provider, which operates the first system 11, or outputted to the display device, by a processing unit or the like. After that, a work for deploying the target application program (e.g. work to install the target application program into extra resources in the first system 11) is carried out by the administrator or the like. Then, the processing ends.

By carrying out the aforementioned processing, the service provider, which operates the first system 11, can reduce the cost required to provide the service.

### Embodiment 2

Next, a second embodiment of this technique will be explained. In the second embodiment, a processing for determining a system in which data is to be disposed is carried out.

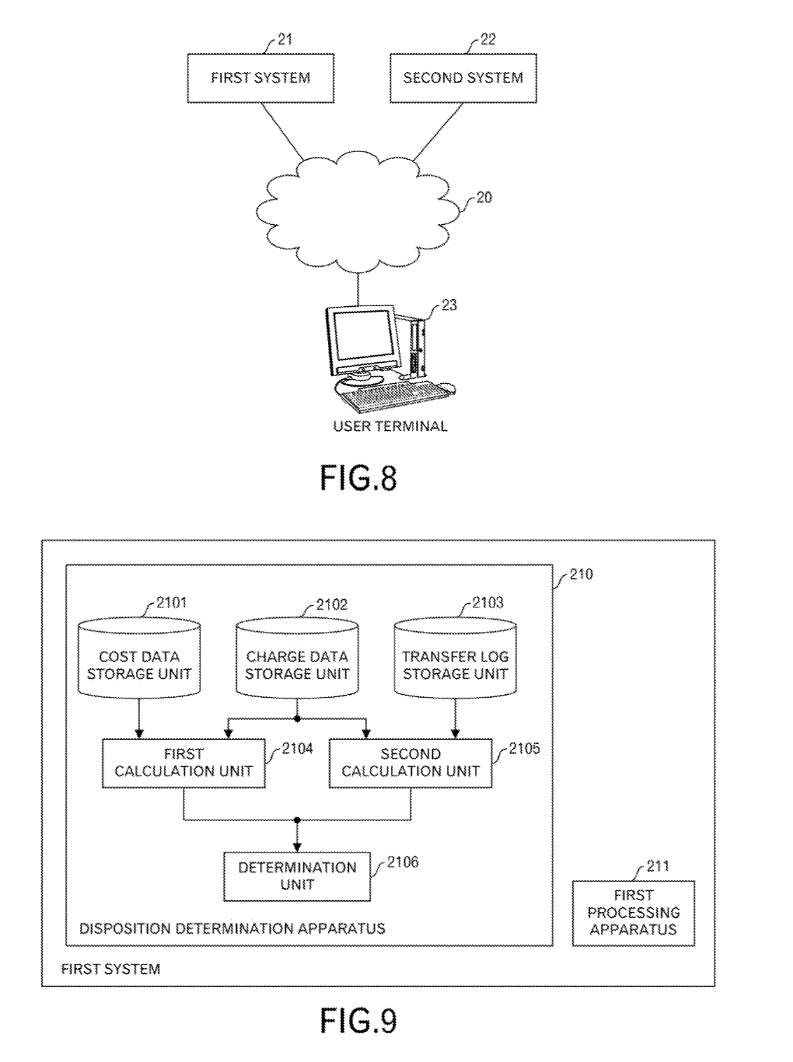

FIG. 8 depicts a system outline diagram relating to the second embodiment.

In an example of FIG. 8, a first system 21, second system 22 and user terminal 23 are connected to a network 20, such as the Internet. Incidentally, in the example of FIG. 8, although only one user terminal 23 is depicted, the number of terminals is not limited.

FIG. 9 depicts a functional block diagram of the first system 21 depicted in FIG. 8. The first system 21 includes a disposition determination apparatus 210 and first processing apparatus 211. The disposition determination apparatus 210 includes a cost data storage unit 2101, charge data storage unit 2102, transfer log storage unit 2103, first calculation unit 2104, second calculation unit 2105 and determination unit 2106.

The first calculation unit 2104 carries out a processing by using data stored in the cost data storage unit 2101 and charge data storage unit 2102, and outputs processing results to the determination unit 2106. The calculation unit 2105 carries out a processing by using data stored in the cost data storage unit 2101, charge data storage unit 2102 and transfer log storage unit 2103, and outputs processing result to the determination unit 2106. The determination unit 2106 uses the processing results from the first calculation unit 2104 and second calculation unit 2105 to carry out a processing for determining a system in which data is to be held. Incidentally, in the following, data to be considered in this embodiment is called “target data”. In addition, the first processing apparatus 211 carries out a processing for the target data in response to a request from the user terminal 23.

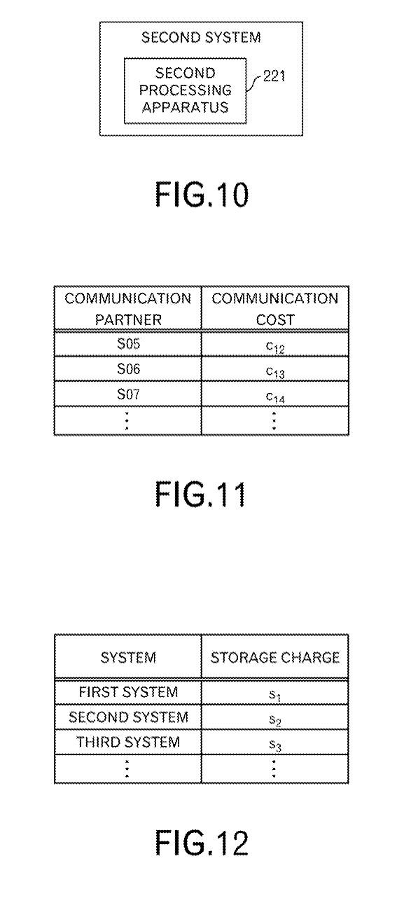

FIG. 10 depicts a functional block diagram of the second system 22 depicted in FIG. 8. The second system 22 includes a second processing apparatus 221. The second processing apparatus 221 carries out a processing for the target data held in the first system 21.

FIG. 11 depicts an example of data stored in the cost data storage unit 2101. In an example of FIG. 11, a table includes a column of an identifier of a communication partner and column of a communication cost. The communication cost is a communication cost caused by transferring the target data. Incidentally, in the second embodiment, it is assumed that there is a contract that the user bears an amount of money, which corresponds to the communication cost caused by the data transfer between the first system and the second system. Then, it is assumed that data of the communication cost which is born by the user is stored in the cost data storage unit 2101.

FIG. 12 depicts an example of data stored in the charge data storage unit 2102. In an example of FIG. 12, a table includes a column of a system and column of a storage charge. Incidentally, the storage charge per one unit capacity may be stored in the column of the storage charge to calculate the total storage charge based on the data capacity and storage charge per one unit capacity.

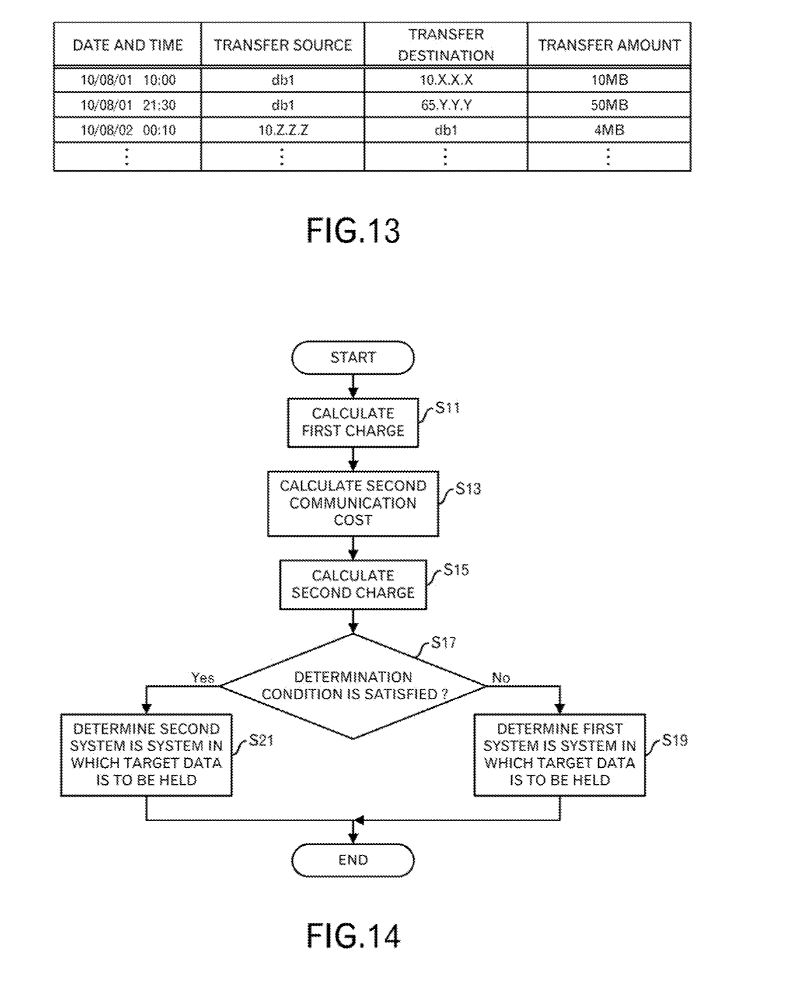

FIG. 13 depicts an example of data stored in the transfer log storage unit 2103. In an example of FIG. 13, a table includes a column of data and time, column of a transfer source, column of a transfer destination and column of a transfer amount. In the transfer amount log data storage 2103, a log is generated and stored by a monitoring unit every time the data is transferred.

Next, processing contents of the system depicted in FIG. 8 is explained by using FIG. 14. Here, a processing will be explained to evaluate which of the first system 21 and second system 22 is better in view of the cost when the data is to be disposed.

First, the first calculation unit 2104 in the disposition determination apparatus 210 reads out the communication cost (hereinafter, referred to a first communication cost) that occurs when the second processing apparatus 221 in the second system 22 carries out a processing for the target data in the first system 21, from the cost data storage unit 2101. Moreover, the first calculation unit 2104 reads out the storage charge (hereinafter, referred to a first storage charge) that occurs when the target data is held in the first system 21, from the charge data storage unit 2102. Then, the first calculation unit 2104 uses the first communication cost and first storage charge to calculate a service charge (hereinafter, referred to a first charge) of the user, which occurs when the target data is held in the first system 21, and stores the calculated first charge into a storage unit such as a main memory (FIG. 14: step S11). The first charge is calculated by a predetermined function f₂(x, y), for example. Here, x represents the first communication cost, and y represents the first storage charge.

Then, the second calculation unit 2105 reads out a transfer amount of the target data used for the processing in the first processing apparatus 211 from the transfer log storage unit 2103, calculates a communication cost (hereinafter, called a second communication cost) that occurs when the target data is held in the second system 22 based on the read transfer amount and communication cost per one unit data amount (e.g. which follows a fee table defined by a telecoms carrier), and stores the calculated second communication cost into the storage unit such as the main memory (step S13).

Moreover, the second calculation unit 2105 reads out the storage charge (hereinafter, called a second storage charge) that occurs when the target data is held in the second system 22, from the charge data storage unit 2102. Then, the second calculation unit 2105 uses the second communication cost and second storage charge to calculate a user's service charge (hereinafter, a second charge) that occurs when the target data is held in the second system 22, and stores the calculated second charge into the storage unit such as the main memory (step S15). The second charge is calculated by a predetermined function f₃(x, y), for example. Here, x represents the second communication cost, and y represents the second storage charge.

Then, the determination unit 2106 uses the processing results of the first calculation unit 2104 and second calculation unit 2105 to determine whether or not a determination condition including a first condition for a relationship between the first charge and second charge is satisfied (step S17).

The first condition may be a condition that the first charge is simply greater than the second charge or a condition that the first charge is greater than the second charge a predetermined amount (or a predetermined ratio). Moreover, a condition that the first charge is greater than the second charge in plural unit periods immediately before, or a condition an average value of the first charges in some months immediately before is greater than an average value of the second charges in some months immediately before may be employed.

Then, when the determination condition is not satisfied (step S17: No route), the determination unit 2106 determines that the first system 21 is a system in which the target data is to be held, and stores data representing that the first system 21 is determined as a storage destination into the storage unit such as the main memory (step S19). This is because it is better in view of the cost that the target data is still held in the first system 21.

On the other hand, when it is determined that determination condition is satisfied (step S17: Yes route), the determination unit 2106 determines that the second system 22 is a system in which the target data is to be held (step S21), and stores data representing that the second system 22 is determined as the storage destination into the storage unit such as the main memory. This is because it is better in view of the cost that the target data is to be held in the second system 22. Then, after the step S21, a processing unit transmits data stored in the storage unit such as the main memory to a terminal of an administrator or the like in the service provider operating the first system 21 or outputs the data to a display device or the like. Then, a work to store the target data into the second system 22 (e.g. work to transfer the target data to the second system 22 through the network, or work to move the target data to the second system 22 through a removable disk or the like) is carried out by the administrator or the like. Then, the processing ends.

By carrying out the aforementioned processing, the user who uses the service provided by the service provider operating the first system 21 can reduce the charge for the service.

### Embodiment 3

Next, the third embodiment will be explained. In the third embodiment, a processing to determine a system in which an application program is to be disposed.

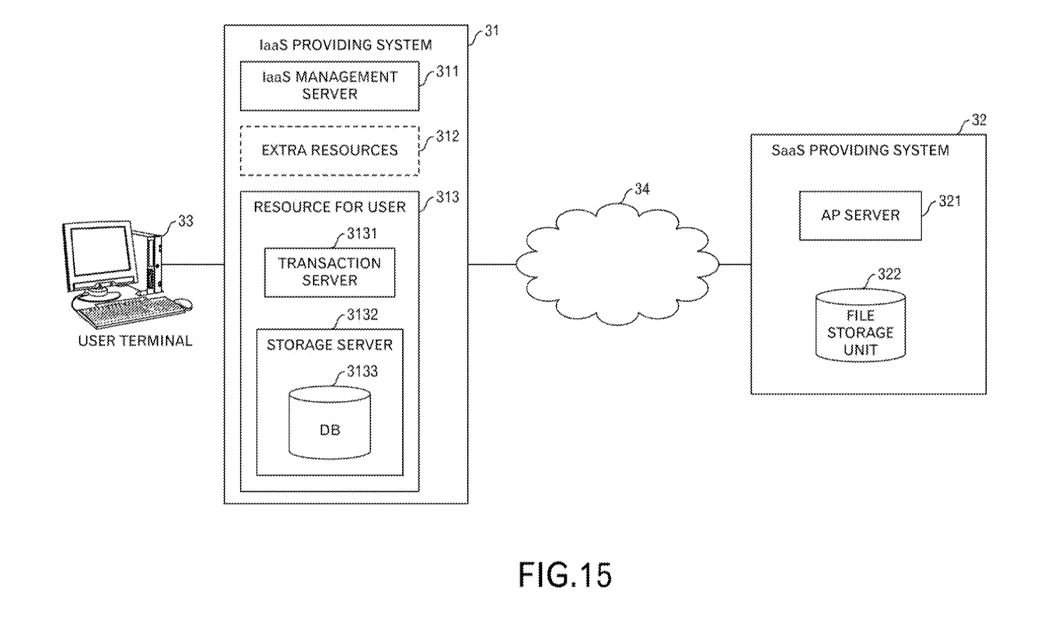

FIG. 15 depicts a system outline diagram relating to the third embodiment of this embodiment. In an example of FIG. 15, a user terminal 33 is connected with an IaaS providing system 31 through an access line or the like. In addition, the IaaS providing system 31 is connected with a SaaS providing system 32 through a network 34 such as the Internet. Incidentally, in the example of FIG. 15, although only one user terminal 33 is depicted, the number of terminals is not limited.

The IaaS providing system 31 includes an IaaS management server 311, extra resources 312 and resource 313 for a user. The resource 313 for the user includes a transaction server 3131 and storage server 3132 including a database (DB) 3133. The transaction server 3131 carries out a processing for data stored in the DB 3133 and the like. The storage server 3132 manages data stored in the DB 3133. Incidentally, the resource 313 for the user is provided for each user (also called “tenant”), and although only one resource 313 is depicted in FIG. 15, the number of resources is not limited. In addition, the extra resources 312 include resources such as physical servers and storage units and/or storage units, which are not used to provide to users.

The SaaS providing system 32 includes an AP server 321 and file storage unit 322. The AP server 321 carries out a processing for received data when a processing request including data to be processed is received from the IaaS providing system 31, and transmits processing results to the IaaS providing system 31. The file storage unit 322 stores data (e.g. image file, which is to be loaded into the main memory) for deploying an application program for providing a service by the SaaS providing system 32.

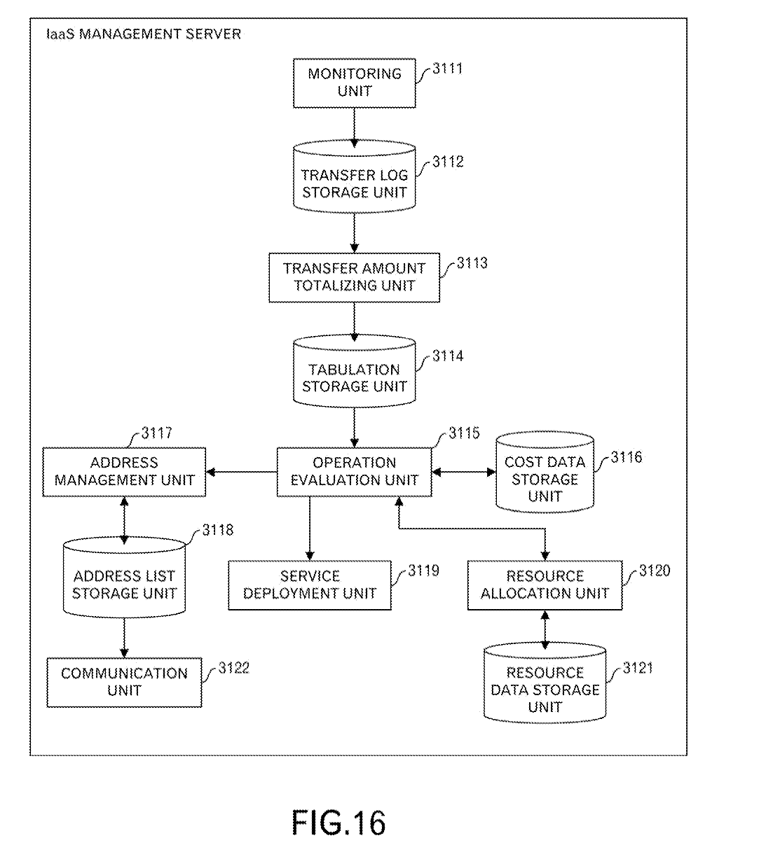

FIG. 16 depicts a functional block diagram of the IaaS management server 311 depicted in FIG. 15. The IaaS management server 311 includes a monitoring unit 3111, transfer log storage unit 3112, transfer amount totalizing unit 3113, tabulation storage unit 3114, operation evaluation unit 3115, cost data storage unit 3116, address management unit 3117, address list storage unit 3118, service deployment unit 3119, resource allocation unit 3120, resource data storage unit 3121 and communication unit 3122.

The monitoring unit 3111 generates a transfer log every time data held in the IaaS providing system 31 (e.g. data stored in the DB 3133) is transferred, and stores the generated transfer log into the transfer log storage unit 3112. The transfer amount totalizing unit 3113 uses data stored in the transfer log storage unit 3112 to carry out a processing to total the transfer amount, and stores processing results into the tabulation storage unit 3114. The operation evaluation unit 3115 uses data stored in the tabulation storage unit 3114 and cost data storage unit 3116 and a list of extra resources, which is notified from the resource allocation unit 3120, to carry out an evaluation processing described later, and notifies the address management unit 3117 and service deployment unit 3119 of processing results. In response to notification from the operation evaluation unit 3115, the address management unit 3117 carries out a processing to update data stored in the address list storage unit 3118 and the like. In response to the notification from the operation evaluation unit 3115, the service deployment unit 3119 carries out a processing to deploy the application program and the like. The communication unit 3122 uses data stored in the address list storage unit 3118 to carryout a processing to transfer a utilization request from the user terminal 33 to a server that should process the utilization request.

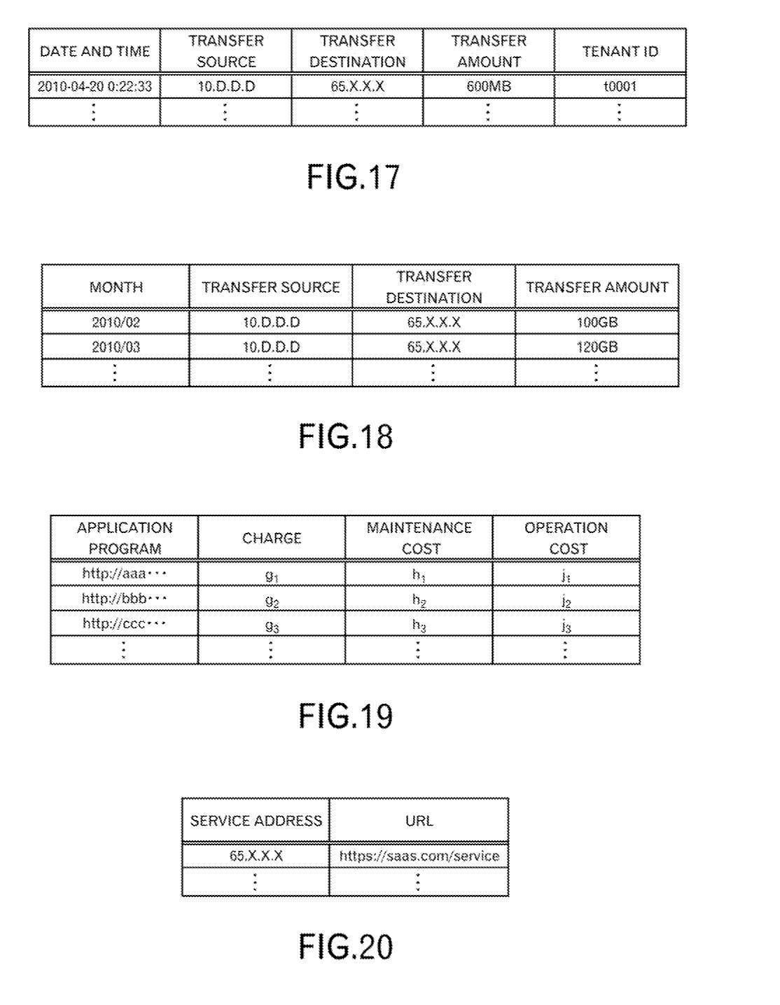

FIG. 17 illustrates an example of data stored in the transfer log storage unit 3112. In an example of FIG. 17, a table includes a column of date and time, column of a transfer source, column of a transfer destination, column of a transfer amount and column of a tenant ID (identifier).

FIG. 18 illustrates an example of data stored in the tabulation storage unit 3114. In an example of FIG. 18, a table includes a column of a month, column of a transfer source, column of a transfer destination and column of a transfer amount.

FIG. 19 illustrates an example of data stored in the cost data storage unit 3116. In an example of FIG. 19, a table includes a column of an identifier (ID) of an application program, column of a charge, column of a maintenance cost and column of an operation cost.

FIG. 20 illustrates an example of a service address table stored in the address list storage unit 3118. In an example of FIG. 20, a table includes a column of a service address and column of a URL (Uniform Resource Locator). Incidentally, in the third embodiment, when the forefront of the number of the service address is “65”, it represents that the application program is deployed in a system other than the IaaS providing system 31.

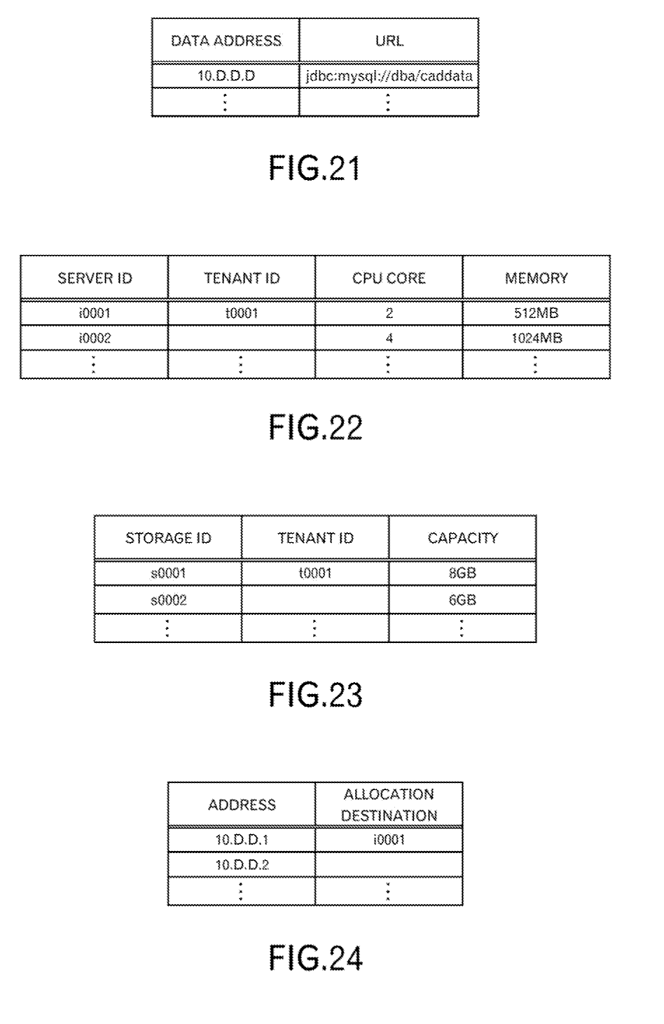

FIG. 21 illustrates an example of a data address table stored in the address list storage unit 3118. In an example of FIG. 21, a table includes a column of a data address and column of a URL. Incidentally, in the third embodiment, when the forefront of the number of the data address is “10”, it represents that data is held in the IaaS providing system 31.

FIG. 22 illustrates an example of a server management table stored in the resource data storage unit 3121. In an example of FIG. 22, a table includes a column of a server ID, column of a tenant ID, column of a CPU core and column of a memory. Incidentally, it represents that the server for which no data is stored in the column of the tenant ID is a server that is not used to provide the user with the service.

FIG. 23 illustrates an example of a storage management table stored in the resource data storage unit 3121. In an example of FIG. 23, a table includes a column of a storage ID, column of a tenant ID and column of a capacity. Incidentally, it is represented that the storage for which no data is stored in the column of the tenant ID is a storage that is not used to provide the user with the service.

FIG. 24 illustrates an example of an address management table stored in the resource data storage unit 3121. In an example of FIG. 24, a table includes a column of an address and column of an allocation destination. Incidentally, the address for which the server ID is not registered in the column of the allocation destination represents an address that is not used to provide the user with the service.

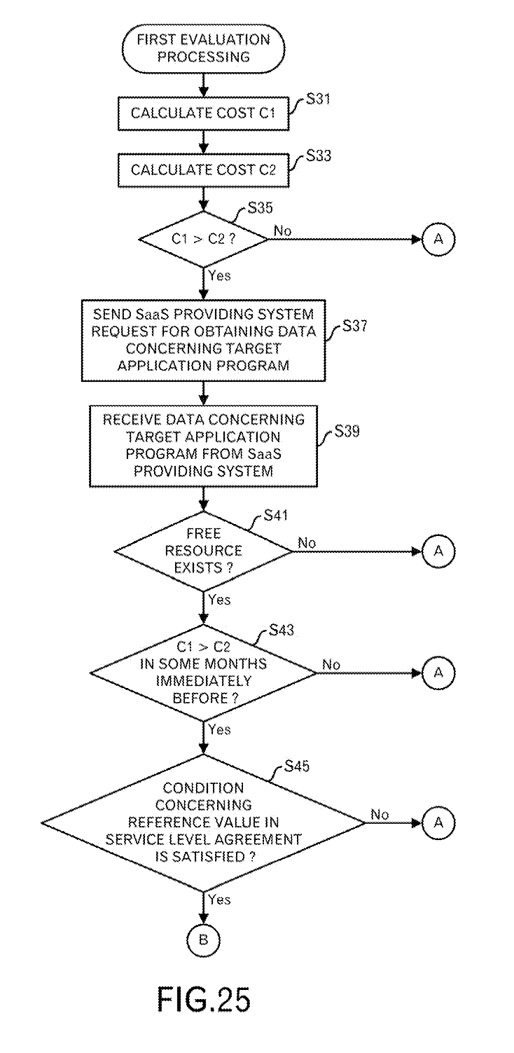

Next, processing contents of the system depicted in FIG. 15 will be explained by using FIGS. 25 to 33. First, a processing (evaluation processing 1) to evaluate which of the IaaS providing system 31 and SaaS providing system 32 is better in view of the cost when the application program is deployed will be explained by using FIGS. 25 to 29. Incidentally, this processing is carried out periodically, for example per one month. Moreover, the application program for providing the service by the SaaS providing system 32 is called a target application program.

First, the operation evaluation unit 3115 included in the IaaS management server 311 in the IaaS providing system 31 calculates a cost C1 by using data stored in the tabulation storage unit 3114, and stores the calculated cost C1 into a storage unit such as a main memory (FIG. 25: step S31). The cost C1 is calculated by a predetermined function f₄(x), for example. Incidentally, in the third embodiment, it is assumed that there is a contract that a fixed amount of money in the communication cost caused by the data transfer that is carried out between the IaaS providing system 31 and the SaaS providing system 32 is born by the user, and the rest of the communication cost is born by the service provider that operates the IaaS providing system 31. Therefore, the function f₄ (x) may be a function f₄(x)=ax−b. Here, “a” is a coefficient defined by the telecoms carrier, for example, and x represents a transfer amount of data used in the processing by the SaaS providing system 32 (e.g. per one month), and “b” is an amount of money the user bears. The cost C1 represents the communication cost (i.e. actually born communication cost) required when causing the AP server 321 in the SaaS providing system 32 to execute the processing for data held in the IaaS providing system 31.

Moreover, the operation evaluation unit 3115 uses data stored in the cost data stored in the cost data storage unit 3116 to calculate a cost C2, and stores the calculated cost C2 into the storage unit such as the main memory (step S33). The cost C2 is calculated by a predetermined function f₅(x, y, z) (e.g. f₅(x, y, z)=x+y+z), for example. Here, x represents a charge for the target application (e.g. license fee per one month), y represents a maintenance fee (for example, per one month), and z represents an operation cost (e.g. electric bill per one month), and these data is read out from the cost table in the cost data storage unit 3116. Incidentally, the cost C2 represents a cost (i.e. predicted cost) required when the target application program is deployed in the IaaS providing system 31.

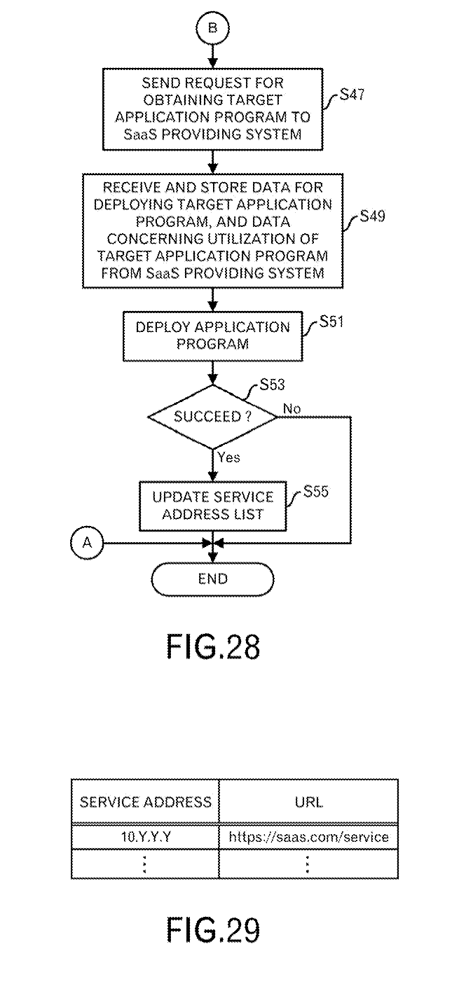

Then, the operation evaluation unit 3115 determines whether or not C1>C2 is satisfied (step S35). Here, they may be simply compared, or it may be determined that C1 is greater than C2 a predetermined amount (or predetermined ratio), for example. Then, when it is determined that C1>C2 is not satisfied (step S35: No route), the cost becomes large when the target application program is deployed in the IaaS providing system 31. Therefore, the processing shifts to a processing in FIG. 28 through a terminal A, and ends.

On the other hand, when it is determined that C1>C2 is satisfied (step S35: Yes route), the operation evaluation unit 3115 transmits a request for obtaining data concerning the target application program to the SaaS providing system 32 (step S37). Then, the operation evaluation unit 3115 receives data (hereinafter, referred to an application descriptor) of the resources to be prepared when the target application program is deployed in the IaaS providing system 31 and data concerning a service level ensured by the SaaS providing system 32, from the SaaS providing system, and stores the received data into the storage unit such as the main memory (step S39).

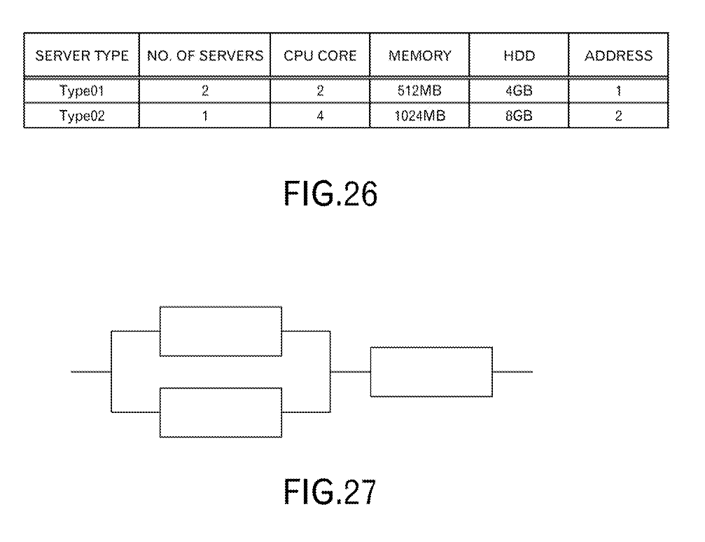

Incidentally, the application descriptor includes data as depicted in FIG. 26, for example. In an example of FIG. 26, the application descriptor includes data concerning a server type, the number of servers, the number of CPU cores, a memory capacity, a capacity of a Hard Disk Drive (HDD) and the number of addresses. Moreover, the application descriptor includes data concerning a connection relationship of the components (e.g. servers and storage units).

Next, the operation evaluation unit 3115 requests a list of the extra resources to the resource allocation unit 3120. Then, the resource allocation unit 3120 generates the list of the extra resources (e.g. a list of the servers, storage units and addresses) based on data stored in the resource data storage unit 3121, and notifies the operation evaluation unit 3115 of this list. Then, the operation evaluation unit 3115 determines, based on the application descriptor received at the step S39 and list of the extra resources, whether or not the resource to be prepared when the target application program is deployed in the IaaS providing system 31 can be secured (step S41). When it is determined that the resource cannot be secured (step S41: No route), the target application program cannot be deployed. Therefore, the processing shifts to a processing of FIG. 28 through the terminal A, and then ends.

On the other hand, when it is determined that the resource can be secured (step S41: Yes route), the operation evaluation unit 3115 extracts the transfer amount of data used for the processing in the SaaS providing system 32 from the tabulation storage unit 3114, and calculates the cost C1 for some months immediately before. Then, the operation evaluation unit 3115 uses the calculated cost C1 and the cost C2 calculated at the step S33 to determine whether or not a condition that the cost C1 is larger than the cost C2 in every month of some months immediately before is satisfied (step S43). Incidentally, at the step S43, a condition that the data transfer amount continuously increases some months may be employed, or a condition that an average value of the costs C1 in some months immediately before is greater than an average value of the costs C2 in some months immediately before may be employed.

Then, when the condition that the cost C1 is larger than the cost C2 in every month of some months immediately before is not satisfied (step S43: No route), the target application program should not be deployed in the IaaS providing system 31. Therefore, the processing shifts to the processing of FIG. 28 through the terminal A, and then ends. On the other hand, when it is determined that the condition that the cost C1 is larger than the cost C2 in every month of some months immediately before is satisfied (step S43: Yes route), the operation evaluation unit 3115 uses the data concerning the service level ensured by the SaaS providing system 32, which was received at the step S39, to determine whether or not the service level when the target application program is deployed in the IaaS providing system 31 satisfies a condition concerning a reference value of an item concerning the service level (step S45).

As an example of a processing carried out at the step S45, here, a processing to determine whether or not the service level satisfies a condition concerning a reference value regarding an operating rate. FIG. 27 illustrates a connection relationship of components, which is defined by the application descriptor received at the step S39. It is assumed that each component is a unit that the server and storage unit are connected serially. In addition, it is assumed that the failure rate of each of the server and storage unit in the IaaS providing system 31 is 0.004%, and the reference value of the service level to be ensured by the SaaS providing system 32 is 99.99%.

In such a case, the operation rate of each component is nearly equal to 0.99992 (=(1−0.00004)*(1−0.00004)), and the operation rate of the entire system is nearly equal to 99.9919993% (=(1−((1−0.99992)*(1−0.99992)))*0.99992). This operation rate is greater than the reference value “99.99%” of the service level to be ensured by the SaaS providing system 32. Therefore, it is determined at the step S45 that the condition concerning the reference value is satisfied. Incidentally, the processing described here is a mere example, and it may be determined that the service levels of other items (e.g. communication speed) satisfy conditions concerning their reference values.

Returning to explanation of FIG. 25, when it is determined that the condition concerning the reference value of the service level to be ensured by the SaaS providing system 32 is satisfied (step S45: No route), the target application program should not be deployed in the IaaS providing system 31. Therefore, the processing shifts to the processing of FIG. 28 through the terminal A, and then ends.

On the other hand, when it is determined that the condition concerning the reference value of the service level to be ensured by the SaaS providing system 32 is satisfied (step S45: Yes route), the processing shifts to step S47 of FIG. 28 through a terminal B.

Shifting to the explanation of FIG. 28, the operation evaluation unit 3115 transmits a request for obtaining the target application program to the SaaS providing system 32 (FIG. 28: step S47). Then, the operation evaluation unit 3115 receives data for deploying the target application program (e.g. image files which can be loaded into the main memory) and data concerning utilization of the target application program (e.g. data concerning the license) from the SaaS providing system 32, and stores the received data into the storage unit such as the main memory (step S49). Incidentally, data concerning the utilization of the application program is shown to the administrator and the like of the IaaS providing system 31 through a display device or the like, and the administrator conducts a predetermined procedure or the like.

Then, the operation evaluation unit 3115 instructs the service deployment unit 3119 to deploy the target application program. After that, the service deployment unit 3119 uses data for deploying the target application program, which was received at the step S49, to carry out a processing for deploying the target application program (step S51). At the step S51, the service deployment unit 3119 displays data on the display device or the like, and prompts the administrator or the like to ensure, from the extra resources 312, resources to be prepared to deploy the target application program. Then, when the resources are ensured from the extra resources 312 and a virtual server is activated, the application program is loaded onto the virtual server.

Then, the service deployment unit 3119 determines whether or not the deployment of the application program is successful (step S53). When it is determined that the deployment is not successful (step S53: No route), the service deployment unit 3119 notifies the administrator or the like to that effect through the display device or the like, and the processing ends. On the other hand, when it is determined that the deployment is successful (step S53: Yes route), the address management unit 3117 changes a service address stored in the address list storage unit 3118 in association with the identifier of the target application program to the service address in the IaaS providing system 31 (step S55). Then, the processing ends.

An example of the service address table stored in the address list storage unit 3118 after carrying out the processing of the step S55 is illustrated in FIG. 29. In an example of FIG. 29, the service address is changed to a service address whose forefront number is “10”. Thus, by changing the service address, it is possible to provide the service by the target application program in the IaaS providing system 31.

By carrying out the aforementioned processing, the service provider operating the IaaS providing system 31 can reduce the cost required to provide the service. In addition, the service provider operating the SaaS providing system 32 can provide the service for more users by utilizing the resources in the IaaS providing system 31. Moreover, the user can receive the service with the short response time when the application program is deployed in the IaaS providing system 31.

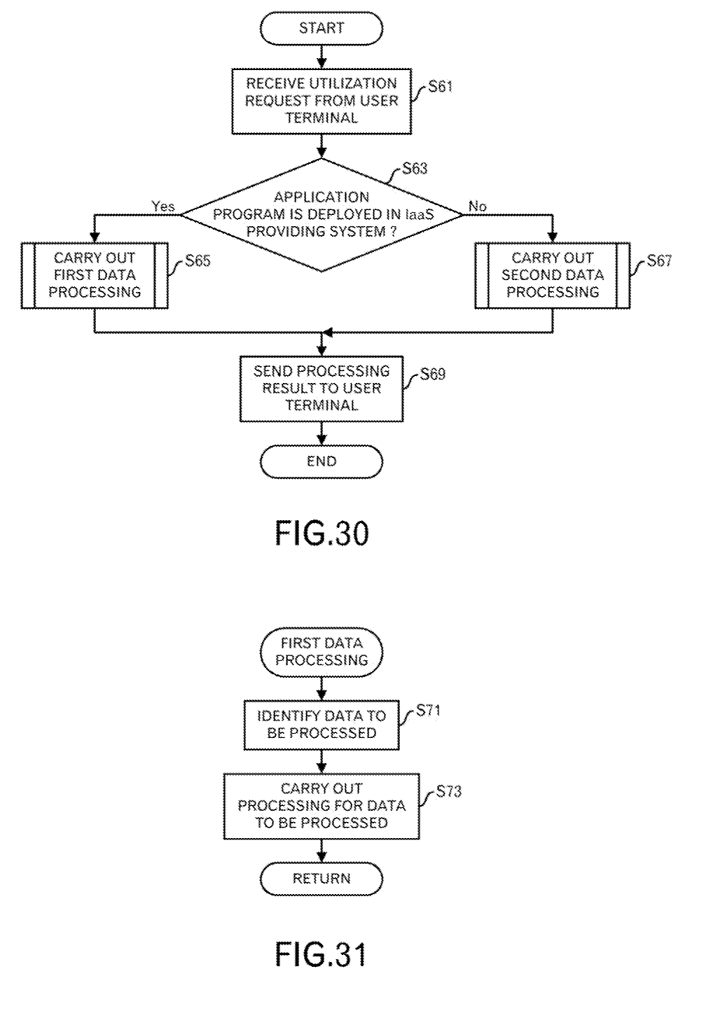

Next, a processing when the IaaS providing system 31 receives the utilization request of the application program from the user terminal 33 will be explained using FIGS. 30 to 32.

First, the communication unit 3122 included in the IaaS management server 311 in the IaaS providing system 31 receives the utilization request of the application program from the user terminal 33, and stores the received utilization request into the storage unit such as the main memory (FIG. 30: step S61). Then, the communication unit 3122 determines whether or not an address stored in the address list storage unit 3118 in association with the identifier (e.g. URL) of the application program included in the utilization request of the application program is an address in the IaaS providing system 31 (step S63). Namely, it is determined that the application program is deployed in the IaaS providing system 31.

Then, when it is determined that the application program is deployed in the IaaS providing system 31 (step S63: Yes route), the communication unit 3122 carries out a first data processing (step S65). The first data processing is explained by using FIG. 31.

First, the communication unit 3122 uses the data address table stored in the address list storage unit 3118 to identify an address of data (hereinafter, referred to data to be processed) designated by a URL, for example, in the utilization request (FIG. 31: step S71). Then, the communication unit 3122 transmits a processing request including the address of the identified data to be processed to a server in which the application program for carrying out a processing relating to the utilization request is deployed (here, a virtual server deployed in the extra resources 312). Then, the virtual server extracts the data to be processed from a database (e.g. DB 3133) to carry out a processing (step S73), and transmits a processing result to the communication unit 3122 in the IaaS management server 311. Then, the processing returns to the calling-source processing.

By carrying out such a processing, even when the application program is deployed in the IaaS providing system 31, the utilization request from the user terminal 33 can be appropriately processed.

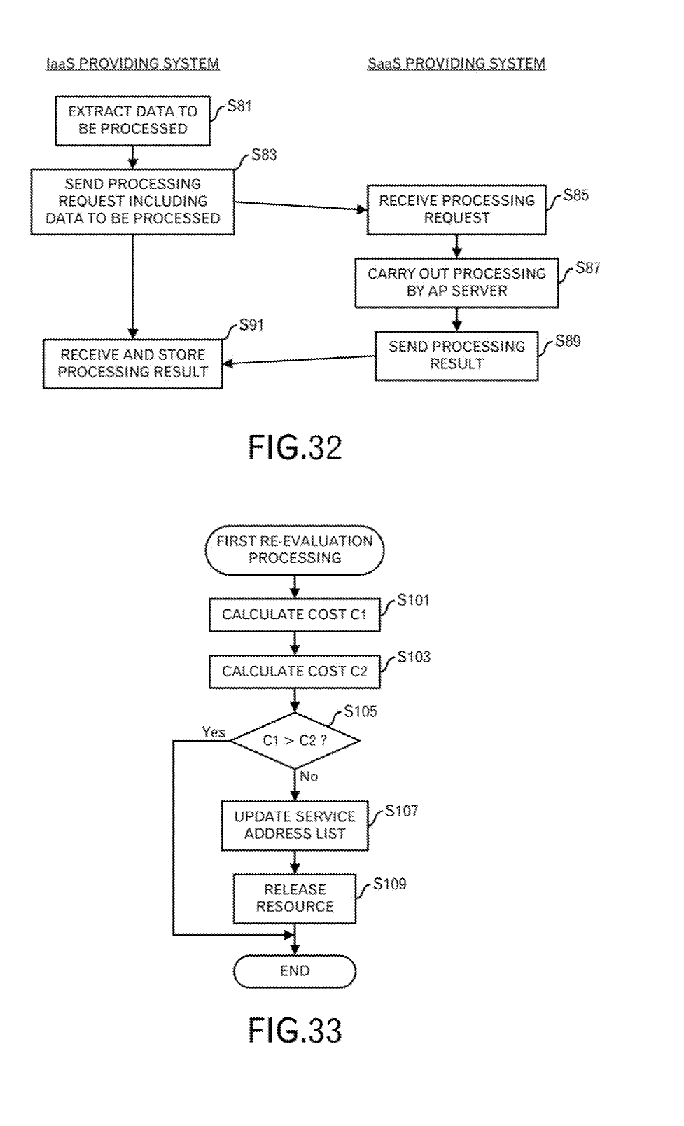

Returning to the explanation of FIG. 30, when it is determined that the application program is not deployed in the IaaS providing system 31 (step S63: No route), the communication unit 3122 carries out a second data processing (step S67). The second data processing is explained by using FIG. 32.

First, the communication unit 3122 uses the data address table stored in the address list storage unit 3118 to identify an address of the data (hereinafter, referred to data to be processed) identified by the URL, for example, in the utilization request, and extracts the data to be processed from a database (e.g. DB 3133) by using the identified address (FIG. 32: step S81). In addition, the communication unit 3122 transmits a processing request including the data to be processed to the SaaS providing system 32 (step S83).

The AP server 321 in the SaaS providing system 32 receives the data to be processed from the IaaS providing system 31 (step S85). Then, the AP server 321 carries out a processing for the data to be processed (step S87), and transmits a processing result to the IaaS providing system 31 (step S89).

The communication unit 3122 in the IaaS providing system 31 receives a processing result to the SaaS providing system 32, and stores the received data into the storage unit such as the main memory (step S91). Then, the processing returns to the calling-source processing.

By carrying out such a processing, even when the application program is not deployed in the IaaS providing system 31, it becomes possible to appropriately carryout a processing for data held in the IaaS providing system 31.

Returning to the explanation of FIG. 30, the communication unit 3122 transmits the processing result at the step S65 or S67 to the user terminal 33 (step S69). Then, the processing ends.

By carrying out the aforementioned processing, even when the application program is deployed in either the IaaS providing system 31 or SaaS providing system 32, it becomes possible to appropriately process the utilization request from the user terminal 33.

Next, a processing (i.e. a first re-evaluation processing) to re-evaluate whether or not the deployment of the application program in the IaaS providing system 31 is better in view of the cost, compared with the deployment of the application program in the SaaS providing system 32 is explained by using FIG. 33. Incidentally, this processing is carried out after a predetermined period (e.g. after one month) elapsed since the application program was deployed in the IaaS providing system 31. Moreover, here, an application program to be considered is called a target application program.

First, the operation evaluation unit 3115 included in the IaaS management server 311 in the IaaS providing system 31 calculates a cost C1, and stores the calculated cost C1 into the storage unit such as the main memory (FIG. 33: step S101). The calculation method of the cost C1 is the same as described at the step S31. However, here, by extracting the transfer amount of data used for the processing by the virtual server from the tabulation storage unit 3114, the data transfer amount between the IaaS providing system 31 and the SaaS providing system 32 is calculated as a predicted value.

Moreover, the operation evaluation unit 3115 calculates the cost C2, and stores the calculated cost C2 into the storage unit such as the main memory (step S103). The calculation method of the cost C2 is the same as described at the step S33.

Then, the operation evaluation unit 3115 determines whether or not C1>C2 is satisfied (step S105). As explained at the step S35, C1 and C2 may be simply compared, or it may be determined whether or not C1 is greater than C2 a predetermined amount (or a predetermined ratio). Then, when it is determined that C1>C2 is satisfied (step S105: Yes route), the cost for the existing deployment of the target application program in the IaaS providing system 31 is lesser. Therefore, the processing ends.

On the other hand, when it is determined that C1>C2 is not satisfied (step S105: No route), the operation evaluation unit 3115 instructs the address manager 3117 to update the address list. Then, the address manager 3117 changes the service address stored in the address list storage unit 3118 in association with the identifier of the target application program to the address of the AP server 321 in the SaaS providing system 32 (e.g. the address whose forefront number starts with “65”) (step S107).

Then, the operation evaluation unit 3115 notifies the service deployment unit 3119 to the effect that the deployment of the target application program is terminated. After that, the service deployment unit 3119 deletes the application program that was loaded in the virtual server, and prompts the administrator or the like to stop the virtual server and release the storage unit through the display device or the like to release the resource (step S109). Then, the processing ends.

By carrying out the aforementioned processing, when it becomes disadvantageous in view of the cost, that the application program is deployed in the IaaS providing system 31, it is possible to return to the original state.

### Embodiment 4

Next, a fourth embodiment of this technique is explained. In the fourth embodiment, a processing for determining a system in which the data is to be disposed.

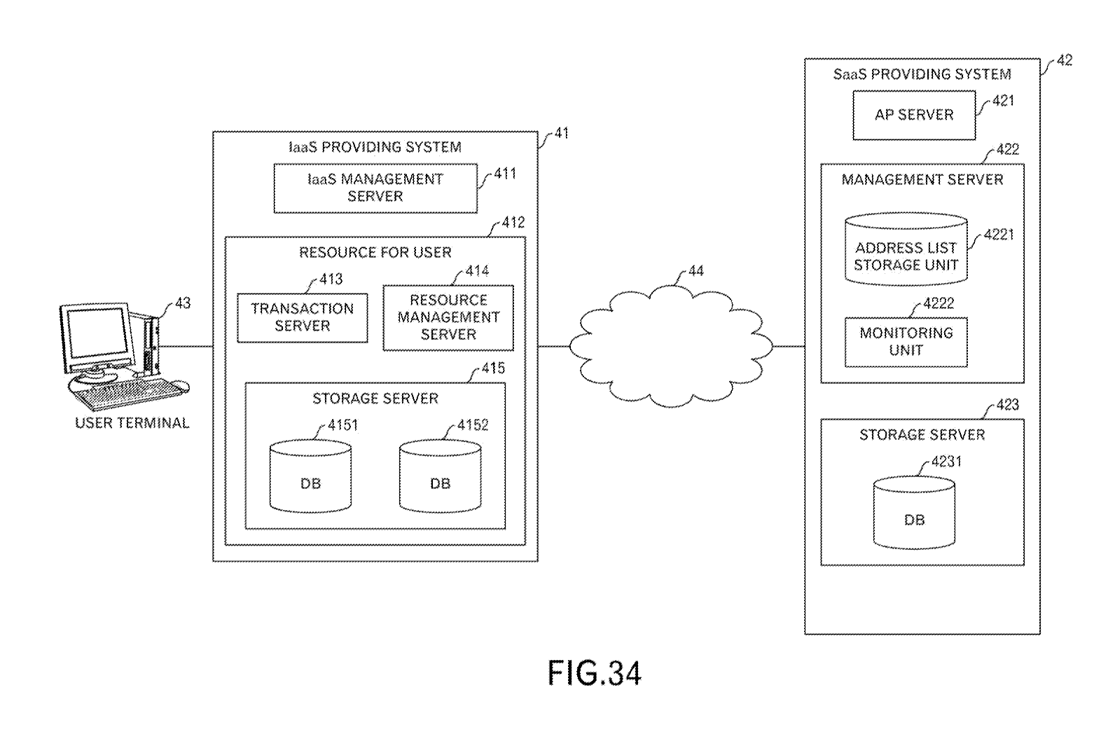

FIG. 34 illustrates a system outline drawing relating to the fourth embodiment. In an example of FIG. 34, a user terminal 43 is connected to an IaaS providing system 41 through an access line or the like, for example. In addition, the IaaS providing system 41 is connected with a SaaS providing system 42 through a network 44 such as the Internet. Incidentally, although only one user terminal 43 is depicted in an example of FIG. 34, the number of terminals is not limited.

The IaaS providing system 41 includes an IaaS management server 411 and resource 412 for a user. Incidentally, the resource 412 for the user is provided for each user (also called a tenant), and although only one resource is depicted in an example of FIG. 34, the number of resources are not limited.

The IaaS management server 411 carries out a processing to manage the resource 412 for the user, and the like. The resource 412 for the user includes a transaction server 413, resource management server 414 and a storage server 415 including a database (DB) 4151 and DB 4152. The transaction server 413 carries out a processing for data stored in the DB 4151 and DB 4152, or the like. The storage server 415 manages the data stored in the DB 4151 and DB 4152.

The SaaS providing system 42 includes an AP server 421, management server 422 and storage server 423 including a DB 4231. The AP server 421 carries out a processing for data received from the IaaS providing system 41 or data (e.g. data stored in the DB 4231) managed in the storage server 423 and the like. The storage server 423 manages the data stored in the DB 4231.

The management server 422 includes an address list storage unit 4221 and monitoring unit 4222. The monitoring unit 4222 generates a transfer log every time the data held in the SaaS providing system 42 (e.g. data stored in the DB 4231) is transferred, and stores the generated transfer logs into a log storage unit.

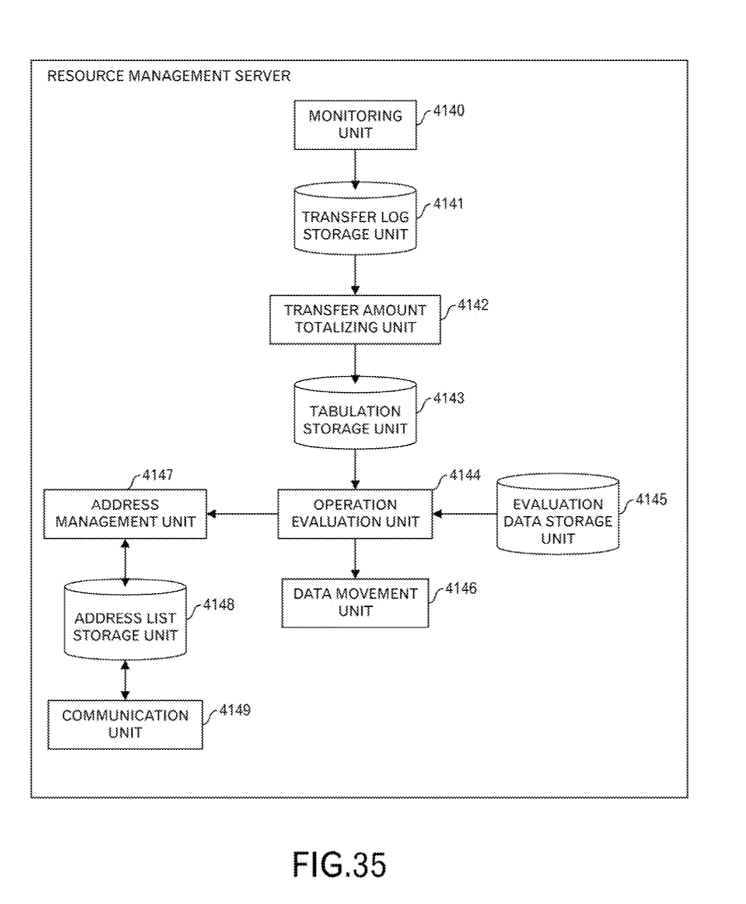

FIG. 35 depicts a functional block diagram of the resource management server 414 depicted in FIG. 34. The resource management server 414 includes a monitoring unit 4140, transfer log storage unit 4141, transfer amount totalizing unit 4142, tabulation storage unit 4143, operation evaluation unit 4144, evaluation data storage unit 4145, data movement unit 4146, address management unit 4147, address list storage unit 4148 and communication unit 4149.

The monitoring 4140 generates a transfer log every time data held in the IaaS providing system 41 (e.g. data stored in the DB 4151 and DB 4152) is transferred, and stores the generated transfer log into the transfer log storage unit 4141. The transfer amount totalizing unit 4142 uses data stored in the transfer log storage unit 4141 to carry out a processing to totalize the transfer amounts, and stores the processing result into the tabulation storage unit 4143. The operation evaluation unit 4144 uses data stored in the tabulation storage unit 4143 and evaluation data storage unit 4145 to carryout an evaluation processing described below, and notifies the address manager 4147 and data movement unit 4146 of processing results. In response to notification from the operation evaluation unit 4144, the address manager 4147 carries out a processing to update the data stored in the address list storage unit 4148. In response to the notification from the operation evaluation unit 4144, the data movement unit 4146 carries out a processing to transmit data held by the IaaS providing system 41 (e.g. data stored in the DB 4151 and DB 4152) to the SaaS providing system. The communication unit 4149 uses data stored in the address list storage unit 4148 to carry out a processing to transfer a utilization request from the user terminal 43 to a server which should process the utilization request.

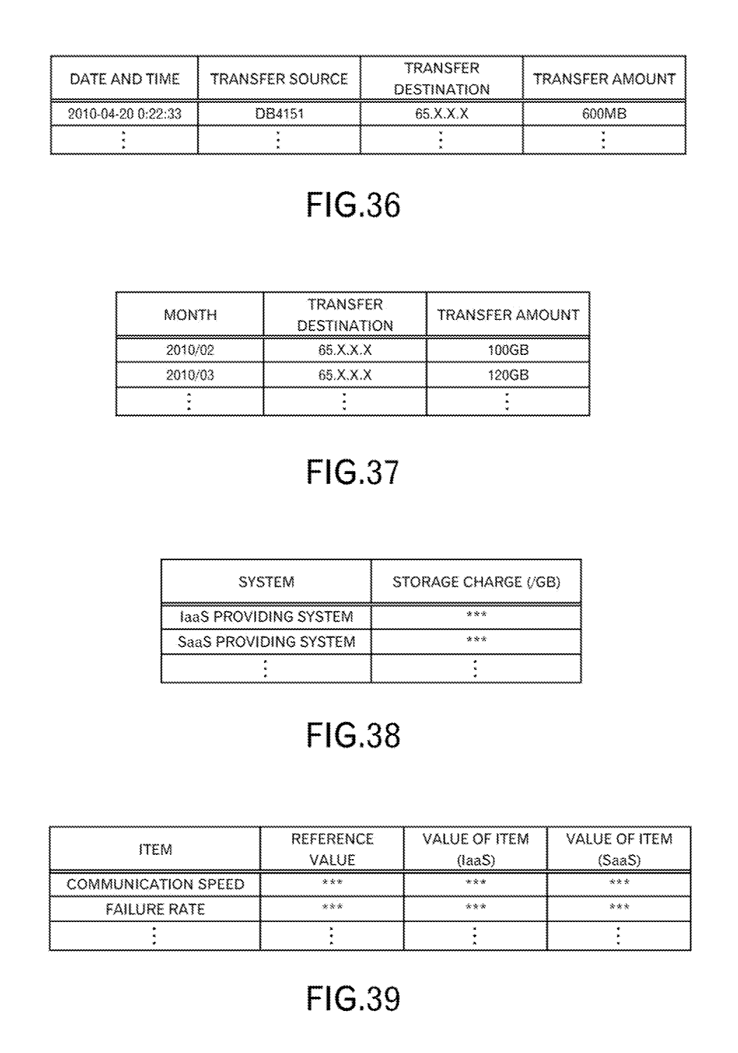

FIG. 36 illustrates an example of data stored in the transfer log storage unit 4141. In an example of FIG. 36, a table includes a column of date and time, column of a transfer source, column of a transfer destination and column of a transfer amount.

FIG. 37 illustrates an example of data stored in the tabulation storage unit 4143. In an example of FIG. 37, a table includes a column of a month, column of a transfer destination and column of a transfer amount. Incidentally, in the tabulation storage unit 4143, data as depicted in the example of FIG. 37 is stored in each database.

FIG. 38 illustrates an example of data stored in the fee table in the evaluation data storage unit 4145. In an example of FIG. 38, a table includes a column of a system and column of a storage charge per one unit capacity.

FIG. 39 illustrates an example of data stored in a service level table in the evaluation data storage unit 4145. In an example of FIG. 39, a table includes a column of an item included in the agreement concerning the service level, column of a reference value for the item, column of a value for the item when the IaaS providing system 41 holds data to be processed and column of a value for the item when the SaaS providing system 42 holds the data to be processed. For example, an actual value is stored in the column of the value for the item when the IaaS providing system 41 holds the data to be processed, for example. In addition, an estimated value may be used for the value for the item when the SaaS providing system 42 holds the data to be processed, or a value obtained from the SaaS providing system 42, which responded to an inquiry, may be used.

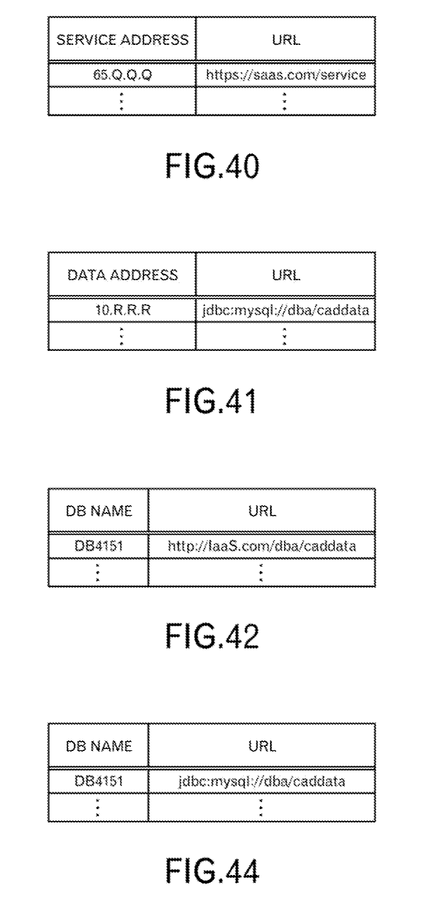

FIG. 40 depicts an example of the service address table stored in the address list storage unit 4148 included in the resource management server in the IaaS providing system 41. In an example of FIG. 40, a table includes a column of an service address and column of a URL. Incidentally, in the fourth embodiment, when the forefront number of the service address is “65”, it represents that the application program is deployed in a system other than the IaaS providing system 41.

FIG. 41 depicts an example of data address table stored in the address list storage unit 4148 included in the resource management server 414 in the IaaS providing system 41. In an example of FIG. 41, a table includes a data address and column of a URL. Incidentally, in the fourth embodiment, when the forefront number of the data address is “10”, it represents data is held in the IaaS providing system 41.

FIG. 42 illustrates an example of data stored in the address list storage unit 4221 included in the management server 422 in the SaaS providing system 42. In an example of FIG. 42, a table includes a column of a DB name and column of the URL.

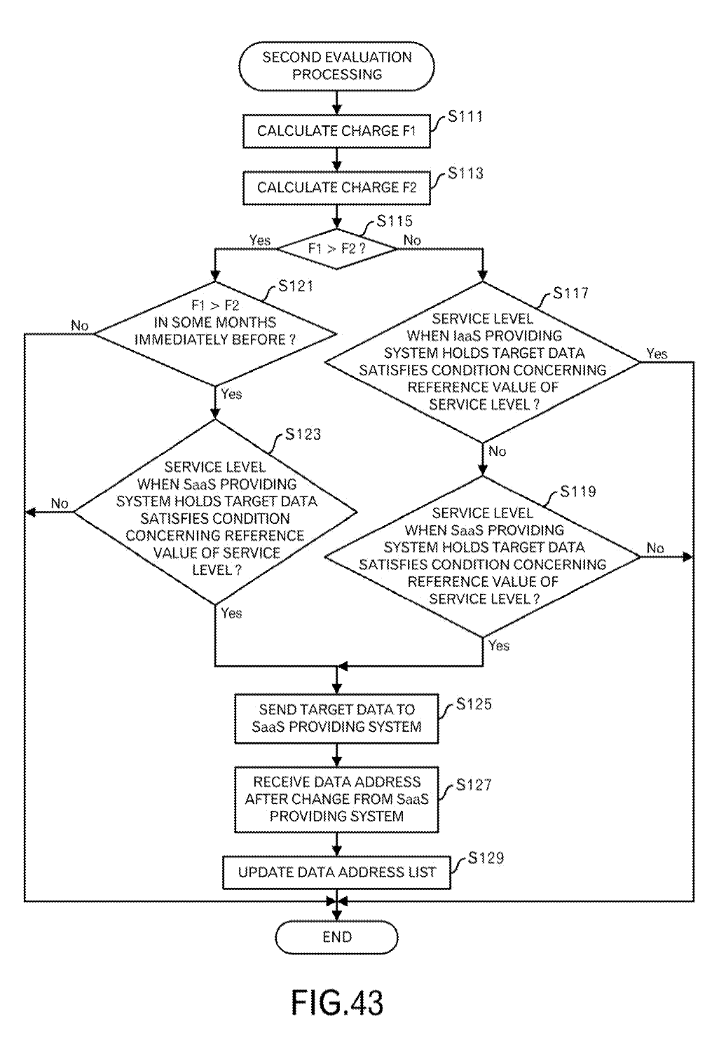

Next, processing contents of the system depicted in FIG. 34 will be explained by using FIGS. 43 to 48. First, a processing (i.e. second evaluation processing) to evaluate which of the IaaS providing system 41 and SaaS providing system 42 is better in view of the cost when the data is disposed will be explained by using FIGS. 43 and 44.

Incidentally, in the following, explanation will be made assuming that data to be considered in this processing (hereinafter, referred to target data) is data stored in the DB 4151. However, this processing may be applied to other data (e.g. data stored in the DB 4152). In addition, in this embodiment, it is assumed that the storage charge in the SaaS providing system 42 is much expensive than the storage charge in the IaaS providing system 41, and a processing amount of the target data in the AP server 421 in the SaaS providing system 42 is more than that in the transaction server 413.

First, the operation evaluation unit 4144 included in the resource management server 414 in the resources 412 for the users calculates a charge F₁ by using the data stored in the tabulation storage unit 4143 and a fee table stored in the evaluation data storage unit 4145, and stores the calculated charge F1 into the storage unit such as the main memory (FIG. 43: step S111). The charge F1 is calculated by a predetermined function f₆(x, y) (e.g. f₆(x, y)=ax+by), for example. Here, “a” represents a coefficient defined by the telecoms carrier, for example, “x” represents a transfer amount (e.g. per one month) of the target data used in the processing by the AP server 421 in the SaaS providing system 42, “b” represents a storage charge per one unit capacity in the IaaS providing system 41, and “y” represents a capacity of the target data. The charge F1 represents a charge the user should bear when the IaaS providing system 41 holds the target data.

In addition, the operation evaluation unit 4144 calculates a charge F2 by using data stored in the tabulation storage unit 4143 and the fee table stored in the evaluation data storage unit 4145, and stores the calculated charge F2 into the storage unit such as the main memory (step S113). The charge F2 is calculated by a predetermined function f₇(x, y) (e.g. f₇(x, y)=ax+cy), for example. Here, “a” represents a coefficient defined by the telecoms carrier, for example, “x” represents a transfer amount (e.g. per one month) of the target data used for the processing by the transaction server 413 in the IaaS providing system 41, “c” represents a storage charge per unit capacity in the SaaS providing system 42, and “y” represents the capacity of the target data. The charge F2 represents a charge to be born by the user when the target data is held in the SaaS providing system 42.

Then, the operation evaluation unit 4144 determines whether or not F1>F2 is satisfied (step S115). Here, they may be simply compared, or it may be determined whether or not F1 is larger than F2 a predetermined amount (or a predetermined rate). Then, when it is determined that F1>F2 is not satisfied (step S115: No route), the operation evaluation unit 4144 uses data in the service level table in stored in the evaluation storage unit 4145 to determine whether or not a value the service level when the target data is held by the IaaS providing system 41 satisfies a condition concerning the reference value for an item concerning the service level (step S117). When the value of the service level satisfies the condition (step S117: Yes route), the existing deployment of the target data in the IaaS providing system 41 is better in view of the cost, and the service level agreement is satisfied. Therefore, the processing ends.

On the other hand, when it is determined that the value of the service level when the IaaS providing system 41 holds the target data does not satisfy the condition concerning the reference value of the item concerning the service level (step S117: No route), the operation evaluation unit 4144 uses data in the service level table stored in the evaluation data storage unit 4145 to determine whether or not a value of the service level when the SaaS providing system 42 holds the target data satisfies the condition concerning a reference value of the item concerning the service level (step S119). When it is determined that the value of the service level does not satisfy the condition (step S119: No route), it is not appropriate that the SaaS providing system 42 holds the target data. Therefore, the processing ends.

On the other hand, when it is determined that the value of the service level when the SaaS providing system 42 holds the target data satisfy a condition that the reference value of the item concerning the service level (step S119: Yes route), the service level agreement is satisfied when the SaaS providing system 42 holds the target data. Therefore, the processing shifts to the step S125.

On the other hand, when it is determined at the step S115 that F1>F2 is satisfied (step S115: Yes route), the operation evaluation unit 4144 uses data stored in the tabulation storage unit 4143 and fee table stored in the evaluation storage unit 4145 to calculate the charge F1 and charge F2 for some months immediately before. Then, the operation evaluation unit 4144 determines whether or not a condition that the charge F1 is greater than the charge F2 for every month in some months immediately before is satisfied (step S121). Incidentally, at the step S121, a condition that the transfer amount of the target data used for the processing by the AP server 421 in the SaaS providing system 42 continuously increases some months immediately before may be employed, or a condition that an average value of the charges F1 in some months immediately before is greater than an average value of the charges F2 in some months immediately before may be employed.

Then, when it is determined that the condition that the charge F1 is greater than the charge F2 for every month in some months immediately before is not satisfied (step S121: No route), the target data should not be held in the SaaS providing system 42. Therefore, the processing ends. On the other hand, when the condition that the charge F1 is greater than the charge F2 for every month in some months immediately before is satisfied (step S121: Yes route), the operation evaluation unit 4144 uses data in the service level table stored in the evaluation data storage unit 4145 to determine whether or not a value of the service level when the SaaS providing system 42 holds the target data satisfies a condition concerning a reference value for an item regarding the service level (step S123). When it is determined that the value of the service level does not satisfy the condition (step S123: No route), the target data should not be held in the SaaS providing system 42. Therefore, the processing ends.

On the other hand, when it is determined that the value of the service level when the SaaS providing system 42 holds the target data satisfies the condition concerning the reference value for the item regarding the service level (step S123: Yes route), the operation evaluation unit 4144 instructs the data movement unit 4146 to carryout a processing for causing the SaaS providing system 42 to hold the target data. Then, the data movement unit 4146 reads out the target data from the DB 4151 to send the target data to the SaaS providing system 42 (step S125).

When the storage server 423 in the SaaS providing system 42 receives the target data, the storage server 423 stores the received target data into a database, and notifies the management server 422 of a data address of the target data. Then, the management server 422 updates the data address stored in the address list storage unit 4221 in association with the identifier of the target data. After that, the management server 422 transmits the data address after the change to the IaaS providing system 41.

FIG. 44 depicts data stored in the address list storage unit 4221 included in the management server 422 in the SaaS providing system 42 after such a processing. In an example of FIG. 44, data stored in the column of the URL is updated to data representing there is target data in the SaaS providing system 42.

The address management unit 4147 included in the resource management server 414 in the IaaS providing system 41 receives the data address after the change from the SaaS providing system 42, and stores the received data address into the storage unit such as the main memory (step S127). Then, the address management unit 4147 changes the address stored in the address list storage unit 4148 in association with the identifier of the target data to the address received at the step S127 (step S129). Then, the processing ends.

By carrying out the aforementioned processing, it becomes possible for the user who is provided with the service by the SaaS providing system 42 through the IaaS providing system 41 to reduce the service charge.

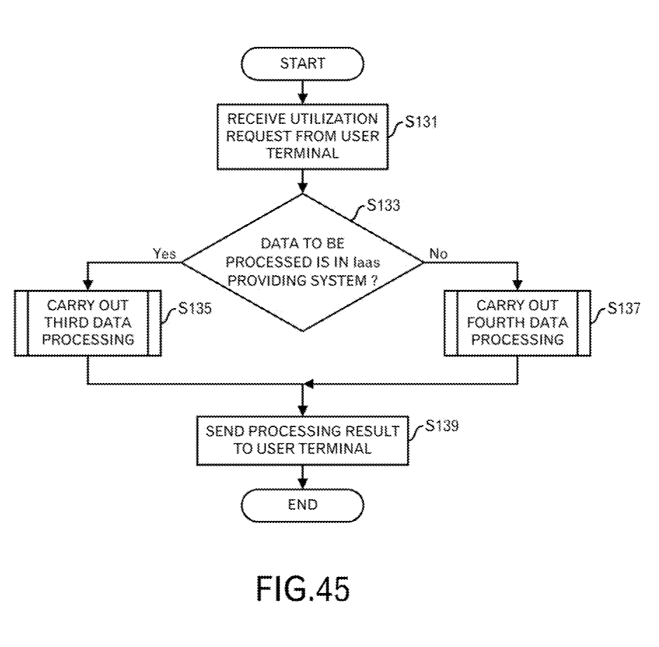

Next, a processing carried out when the IaaS providing system 41 receives a utilization request of an application program from the user terminal 43 will be explained using FIGS. 45 to 47.

First, the communication unit 4149 included in the resource management server 414 in the IaaS providing system 41 receives the utilization request of the application program from the user terminal 43, and stores the received utilization request into the storage unit such as the main memory (FIG. 45: step S131). Then, the communication unit 4149 determines whether or not the address stored in the address list storage unit 4148 in association with an identifier (e.g. URL) of the data included in the utilization request is an address in the IaaS providing system 41 (step S133). Namely, it is determined whether or not the IaaS providing system 41 holds the data to be processed.

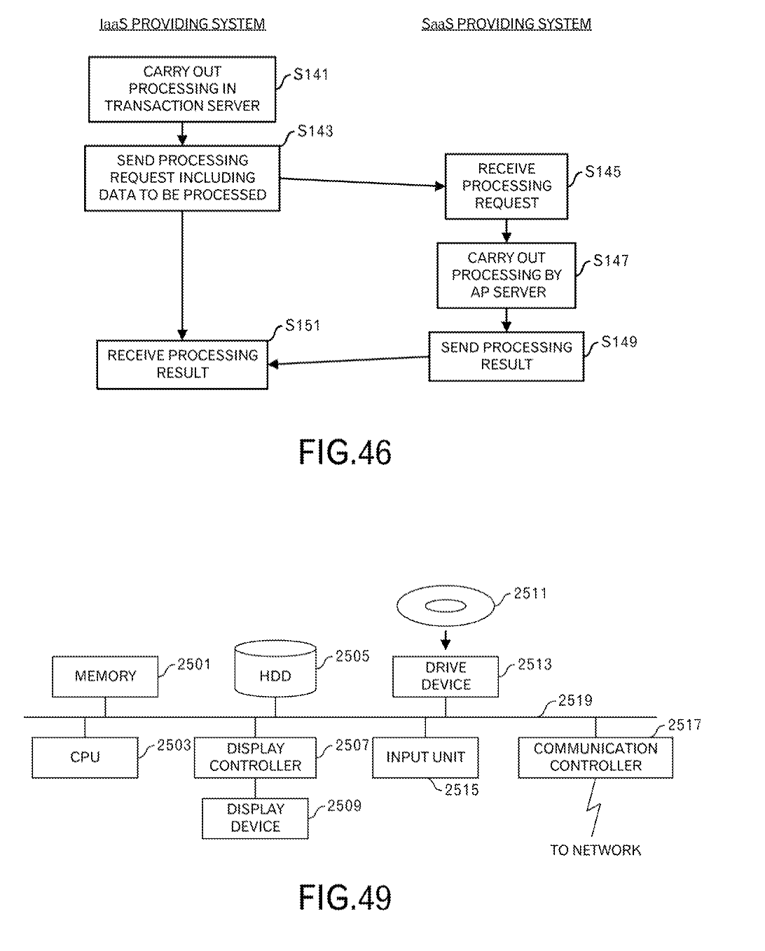

Then, when it is determined that the IaaS providing system 41 holds the data to be processed (S133: Yes route), the communication unit 4149 carries out a third data processing (step S135). The third data processing is explained by using FIG. 46.

First, the communication unit 4149 transmits a request for a processing for the data to be processed to the transaction server 413. Then, the transaction server carries out the processing for the data to be processed (FIG. 46: step S141).

In addition, the communication unit 4149 extracts the data to be processed by using the data address identified at the step S131 from a database (e.g. DB 4152), and transmits a processing request including the data to be processed to the SaaS providing system 42 (step S143).

The AP server 421 in the SaaS providing system 42 receives the processing request including the data to be processed from the IaaS providing system 41 (step S145). Then, the AP server 421 carries out a processing for the data to be processed (step S147), and transmits a processing result to the IaaS providing system 41 (step S149).

The communication unit 4149 included in the resource management server 414 in the IaaS providing system 41 receives the processing result from the SaaS providing system 42, and stores the received processing result into the storage unit such as the main memory (step S151). Then, the processing returns to the calling-source processing.

By carrying out the aforementioned processing, it becomes possible to cause the AP server 421 in the SaaS providing system 42 to carryout a processing even when the data to be processed is held by the IaaS providing system 41.

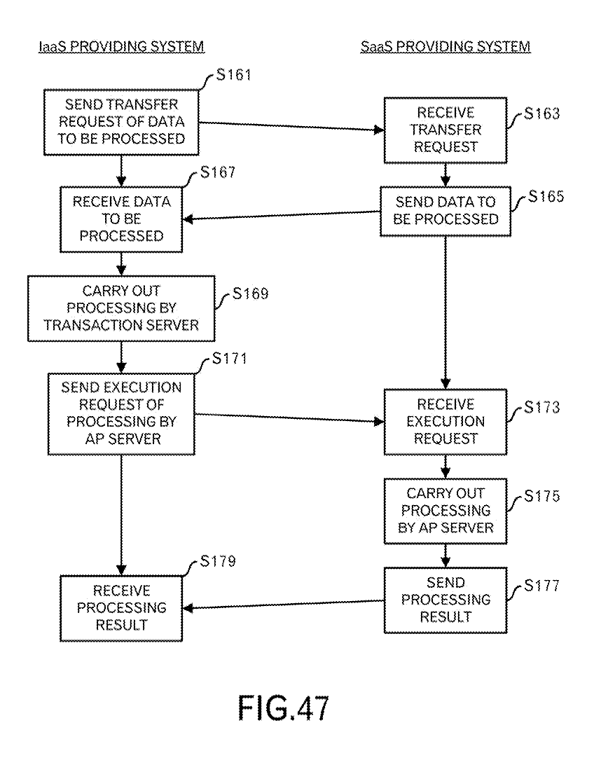

Returning to the explanation of FIG. 45, when it is determined that the IaaS providing system 41 does not hold the data to be processed (step S133: No route), the communication unit 4149 carries out a fourth data processing (step S137). The fourth data processing is explained by using FIG. 47.

First, the communication unit 4149 transmits a transfer request of the data to be processed to the SaaS providing system 42 (FIG. 47: step S161). The storage server 423 in the SaaS providing system 42 receives the transfer request from the IaaS providing system 41 (step S163). Then, the storage server 423 reads out the data to be processed from a database (e.g. DB 4231), and transmits the read data to the IaaS providing system 41 (step S165).

The transaction server 413 in the IaaS providing system 41 receives the data to be processed from the SaaS providing system 42, and stores the received data into the storage unit such as the main memory (step S167). Then, the transaction server 413 carries out a processing for the data to be processed (step S169).

The communication unit 4149 transmits an execution request of the processing by the AP server 421 to the SaaS providing system 42 (step S171). Then, the AP server 421 in the SaaS providing system 42 receives the execution request from the IaaS providing system 41 (step S173). After that, the AP server 421 identifies a data address stored in the address list storage unit 4221 in association with the identifier of the data to be processed, and extracts the data to be processed from a database (e.g. DB 4231) by using the identified data address. Then, the AP server 421 carries out the processing for the data to be processed (step S175), and transmits the processing result to the IaaS providing system 41 (step S177).

The communication unit 4149 in the IaaS providing system 41 receives the processing result from the SaaS providing system 42, and stores the processing result into the storage unit such as the main memory (step S179). Then, the processing returns to the calling-source processing.

By carrying out the aforementioned processing, even when the data to be processed is held in the SaaS providing system 42, it becomes possible to appropriately carry out a processing for the data to be processed, by the transaction server 413.

Returning to the explanation of FIG. 45, the communication unit 4149 transmits the processing result obtained at the step S135 or S137 to the user terminal 43 (step S139). Then, the processing ends.

By carrying out the aforementioned processing, even when the data to be processed is held in either the IaaS providing system 41 or the SaaS providing system 42, it becomes possible to appropriately process the utilization request from the user terminal 43.

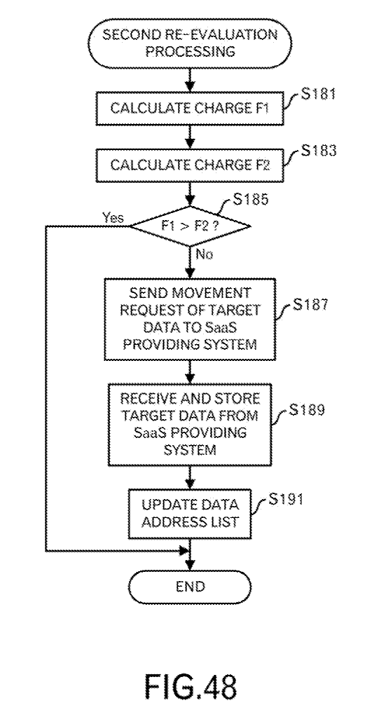

Next, a processing (second re-evaluation processing) to re-evaluate whether or not it is better in view of the cost that the SaaS providing system 42 holds data, compared with a case that the IaaS providing system 41 holds data is explained using FIG. 48. Incidentally, this processing may be executed after a predetermined period elapsed (e.g. after one month) since the data is held in the SaaS providing system 42, or this processing may be carried out when the SaaS providing system 42 originally holds the data. Moreover, here, the data to be processed is called “target data”.

First, the operation evaluation unit 4144 included in the IaaS providing system 41 uses the transfer amount of the target data used for the processing by the AP server 421 in the SaaS providing system 42 and the fee table stored in the evaluation data storage unit 4145 to calculate the charge F1 (i.e. a charge that occurs when the target data is held in the IaaS providing system 41), and stores the calculated charge F1 into the storage unit such as the main memory (FIG. 48: step S181). The calculation method of the charge F1 is the same as described at the step S111. Incidentally, the transfer amount of the target data used for the processing by the AP server 421 is data generated by the monitoring unit 4222 in the SaaS providing system 42, and are obtained from the SaaS providing system 42.

In addition, the operation evaluation unit 4144 calculates the charge F2 by using the data stored in the tabulation storage unit 4143 and the fee table stored in the evaluation data storage unit 4145, and stores the calculated charge F2 into the storage unit such as the main memory (step S183). The calculation method of the charge F2 is the same as described at the step S113. However, as for the storage charge in the SaaS providing system 42, an actual charge may be obtained as account information from the SaaS providing system 42.

Then, the operation evaluation unit 4144 determines whether or not F1>F2 is satisfied (step S185). As explained at the step S115, F1 may be simply compared with F2, or it may be determined whether or not F1 is greater than F2 a predetermined amount (or predetermined rate). Then, when it is determined that F1>F2 is satisfied (step S185: Yes route), the charge of the user is cheaper in a case where the SaaS providing system 42 holds the target data like the current state. Therefore, the processing ends. On the other hand, when it is determined that F1>F2 is not satisfied (step S185: No route), the operation evaluation unit 4144 transmits a movement request of the target data to the SaaS providing system 42 (step S187).

When the storage server 423 in the SaaS providing system 42 receives the movement request of the target data from the IaaS providing system 41, the storage server 423 transmits the target data to the IaaS providing system 41.

Then, the storage server 415 in the IaaS providing system 41 receives the target data from the SaaS providing system 42, and the storage server 415 stores the target data into a data storage unit (step S189). In addition, the storage server 415 transmits a data address newly allocated to the target data to the SaaS providing system 42. In response to this, the management server 422 in the SaaS providing system 42 updates the data address stored in the address list storage unit 4221 in association with the identifier of the target data to the data address after the change.

Furthermore, the storage server 415 in the IaaS providing system 41 notifies the address manager 4147 in the resource management server 414 of the data address after the change. Then, the address manager 4147 updates the data address stored in the address list storage unit 4148 in association with the identifier of the target data to the data address after the change (step S191). Then, the processing ends.

By carrying out the aforementioned processing, when the charge born by the user becomes expensive in case where the data is held by the SaaS providing system 42, it is possible to return the storage state of the data to the original state.

Although the embodiments of this technique were explained, this technique is not limited to those embodiments. For example, the functional block diagrams of the aforementioned IaaS providing server 311 and resource management server 414 may not always correspond to actual program module configurations.

In addition, the structures of the respective aforementioned tables are mere examples, and other structures may be employed. Furthermore, in the processing flows, as long as the processing results do not change, the order of the steps may be exchanged. Moreover, the steps may be executed in parallel.

In addition, the processing apparatus 120, the first processing apparatus 211, the second processing apparatus 221, the disposition determination apparatuses 110 and 210, the IaaS management servers 311 and 411, the transaction servers 3131 and 413, the AP servers 321 and 421, the resource management server 414, the storage servers 3132, 415 and 423, the management servers 422 and the user terminals 13 to 43 are computer devices as shown in FIG. 49. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 49. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the computer-readable removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

Incidentally, each processing unit such as the transfer amount totalizing unit 3113, operation evaluation unit 3115 and the like may be realized by a combination of the CPU 2503 and programs, in other words, by the CPU 2503 executing the programs. More specifically, the CPU 2503 operates according to the program stored in HDD 2505 and/or memory 2501 to function as the aforementioned processing units. The respective processing units in FIGS. 34 and 35 are similarly configured as described above.

Moreover, each data storage unit such as the transfer log storage unit 3112, tabulation storage unit 3114 and the like, which were depicted in FIGS. 15 and 16 may be implemented as the memory 2501 and/or HDD 2505 in FIG. 49. The respective data storage units in FIGS. 34 and 35 may be implemented similarly.

The aforementioned embodiments are outlined as follows:

A disposition determination method relating to a first aspect of this technique is executed by a computer included in a first system. Then, this disposition determination method includes: (A) reading out, from a first cost data storage unit, data of a first cost that is a cost for communication with a processing apparatus that is included in a second system and carries out a processing by an application program for data held in a first system, and storing the read data into a storage unit; (B) calculating a second cost that is a cost that occurs when the application program is disposed in the first system, by using data of a charge for use of the application program, which is stored in a second cost data storage unit, data of a cost required for a maintenance and operation for an apparatus for carrying out a processing by the application, and storing the calculated second cost into the storage unit; (C) determining whether or not a disposition destination determination condition including a first condition for a relationship between the first cost and the second cost, which are stored in the storage unit, is satisfied; and (D) upon detecting that it is determined that the disposition destination determination condition is satisfied, determining that the first system is a system in which the application program is to be disposed.

Thus, when the disposition destination of the application program is determined after considering the relationship between the first cost (i.e. present cost) and the second cost (i.e. predicted cost), it becomes possible for the service provider providing the service by the first system to reduce the cost required for providing the service.

In addition, the aforementioned method may further include: (E) before the determining, reading out, from a disposition data storage unit, data of a resource to be allocated when the application program is disposed in the first system. Then, the aforementioned disposition destination determination condition may include a second condition that the resource to be allocated when the application program is disposed can be secured in the first system. This may be determined based on data stored in a resource data storage unit storing data of resources included in the first system. Thus, it becomes possible to confirm not only whether or not it is better in view of the cost but also whether or not the application program in the first system can actually be disposed.

Moreover, the aforementioned first condition may include a condition that the first cost is greater than the second cost in plural unit periods immediately before. For example, even when the first cost is greater than the second cost in the unit period immediately before, the first cost temporarily becomes greater in some reasons, and this state may not be constant. Then, when the first condition includes the aforementioned condition, it becomes possible to appropriately determine whether or not the application program should be deployed in the first system.

In addition, the aforementioned disposition destination determination condition may include a third condition that a value of a service level when the application program is disposed in the first system satisfies a condition concerning a reference value of an item included in an agreement regarding the service level. Thus, it becomes possible to dispose the application program in the first system after it is confirmed that the service level defined in the contract is maintained.

In addition, the aforementioned method may further include: (F) when it is determined that the first system is the system in which the application program is to be disposed, reading out, from a disposition data storage unit, data for disposing (or deploying) the application program, and causing the application program to be in a usable state in the first system; and (G) changing an address stored in the address storage unit in association with an identifier of the application program to an address in the first system. Thus, it becomes possible to actually request the application program in the first system to execute the processing.

The disposition determination method relating to a second aspect of the embodiments is executed by a computer included in the first system. Then, this disposition determination method includes: (H) reading out, from a cost data storage unit, a first communication cost that is a communication cost that occurs when a second processing apparatus in a second apparatus carries out a processing for a specific data used in a processing by a first processing apparatus in a first system, reading out, from a charge data storage unit, a first storage charge that is a storage charge that occurs when the specific data is held by the first system, calculating a first charge that is a charge for a service, which occurs when the specific data is held in the first system, by using the first communication cost and the first storage charge, and storing the calculated first charge into a storage unit; (I) reading out a transfer amount of data that is used in a processing by the first processing apparatus and used in a communication with the first processing apparatus among the specific data, from a transfer log storage unit storing transfer logs generated in response to data transfer, calculating, by using the read transfer amount, a second communication cost that is a communication cost presumed to occur when the first processing apparatus in the first system carries out a processing for the specific data when the specific data is held by the second system, and storing the calculated second communication cost into the storage unit; (J) reading out, from the charge data storage unit, a second storage charge that is a storage charge that occurs when the specific data is held by the second system, calculating, by using the second communication cost stored in the storage unit and the second storage charge, a second charge that is a charge for a service, which occurs when the specific data is held by the second system, and storing the calculated second charge into the storage unit; (K) determining whether or not a determination condition including a first condition for a relationship between the first charge and the second charge, which are stored in the storage unit is satisfied; and (L) upon detecting that it is determined that the determination condition is satisfied, determining that the second system is a system in which the specific data is to be held.

Thus, when the system in which the specific data is held is determined after considering the relationship between the first charge (i.e. present charge) and the second charge (i.e. predicted charge), it becomes possible for the user who uses the service by the first and second systems to reduce the charge for the service.

In addition, the aforementioned first condition may include a condition that the first charge is greater than the second charge in plural unit periods immediately before. For example, even when the first charge is greater than the second charge in a unit period immediately before, this case may be temporarily caused in some reasons, and may not be constant. Then, by employing the aforementioned condition, it is possible to appropriately determine whether or not the specific data should be held in the second system.

In addition, the aforementioned determination condition may include a second condition that a value of a service level when the second system holds the specific data satisfies a condition concerning a reference value of an item included in an agreement regarding the service level. After it is confirmed that the service level defined in the contract can be maintained, it is determined that the specific data is held in the second system.

In addition, the aforementioned method may further include: (M) when it is determined that the determination condition is not satisfied, determining whether or not a value of a service level when the first system holds the specific data satisfies a condition concerning a reference value of an item included in an agreement regarding the service level; (N) when it is determined that the value of the service level when the first system holds the specific data do not satisfy the condition concerning the reference value of the item included in the agreement regarding the service level, determining whether or not a value of a service level when the second system holds the specific data satisfies the condition concerning the reference value of the item included in the agreement regarding the service level; and (O) when it is determined that the value of the service level when the second system holds the specific data satisfies the condition concerning the reference value of the item included in the agreement regarding the service level, determining that the second system is a system in which the specific data is held. When the first system holds the specific data, there is a case where the service level of the processing by the second processing apparatus is disadvantageous in view of the processing speed or the like, compared with a case where the second system holds the specific data. Then, when the service level defined in the contract cannot be maintained when the first system holds the specific data, the specific data is held in the second system in order to maintain the service level even when the charge becomes expensive.

Moreover, the aforementioned method may further include: (P) when it is determined that the second system is a system in which the specific data is held, transmitting the specific data to the second system; and (Q) when an address of the specific data in the second system is received from the second system, changing an address stored in an address storage unit in association with an identifier of the specific data to the received address. Thus, it becomes possible for the first processing apparatus in the first system to carry out a processing for the specific data in the second system.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory medium storing a program for causing a computer included in a first system to execute a process, the process comprising:
obtaining data of a first cost that represents a communication cost for communication with a processing apparatus that is included in a second system and carries out a processing by an application program for data held in the first system;
calculating a second cost that represents a cost that occurs when the application program is disposed in the first system by using data of a charge for use of the application program and data of a cost required for maintenance and operation for an apparatus for carrying out a processing by the application program;
determining whether a first condition including a second condition concerning a relationship between the first cost and the second cost is satisfied; and
upon detecting that the first condition is satisfied, storing data representing that the first system is a system in which the application program is to be disposed.

2. The computer-readable, non-transitory medium as set forth in claim 1, the process further comprising:
before the determining, obtaining data of a resource to be allocated when the application program is disposed in the first system, and
wherein the first condition includes a third condition that the resource to be allocated when the application program is disposed is secured in the first system.

3. The computer-readable, non-transitory storage medium as set forth in claim 1, wherein the second condition includes a condition that the first cost is greater than the second cost in a plurality of unit periods immediately before.

4. The computer-readable, non-transitory medium as set forth in claim 1, wherein the first condition includes a fourth condition that a value of a service level when the application program is disposed in the first system satisfies a condition concerning a reference value of an item included in an agreement regarding the service level.

5. The computer-readable, non-transitory medium as set forth in claim 2, the process further comprising:
upon detecting the first condition is satisfied, enabling the application program to be in a usable state in the first system by using data to dispose the application program; and
changing an address for the application program to an address of the application program in the first system.

6. A computer-readable, non-transitory medium storing a program for causing a computer included in a first system to execute a process, the process comprising:
obtaining a first communication cost that represents a communication cost that occurs when a second processing apparatus in a second system carries out a processing for a specific data used in a processing by a first processing apparatus in the first system, and obtaining a first storage charge that represents a storage charge that occurs when the specific data is held by the first system to calculate a first charge that represents a charge for a service, which occurs when the specific data is held in the first system, by using the first communication cost and the first storage charge;
obtaining a transfer amount of data that is used in a processing by the first processing apparatus and used in a communication with the first processing apparatus among the specific data, from a transfer log storage unit storing transfer logs generated in response to data transfer, to calculate, by using the obtained transfer amount, a second communication cost that represents a communication cost presumed to occur when the first processing apparatus in the first system carries out a processing for the specific data when the specific data is held by the second system;
obtaining a second storage charge that represents a storage charge that occurs when the specific data is held by the second system to calculate, by using the second communication cost and the second storage charge, a second charge that represents a charge for a service, which occurs when the specific data is held by the second system;
determining whether a first condition including a second condition for a relationship between the first charge and the second charge is satisfied; and
upon detecting that the first condition is satisfied, storing data representing that the second system is a system in which the specific data is to be held.

7. The computer-readable, non-transitory medium as set forth in claim 6, wherein the second condition includes a condition that the first charge is greater than the second charge in a plurality of unit periods immediately before.

8. The computer-readable, non-transitory medium as set forth in claim 6, wherein the first condition includes a condition that a value of a service level when the second system holds the specific data satisfies a third condition concerning a reference level of an item included in an agreement concerning the service level.

9. The computer-readable, non-transitory medium as set forth in claim 6, the process further comprising:
upon detecting that the first condition is not satisfied, determining whether a first value of a service level when the first system holds the specific data satisfies a fourth condition concerning a reference value of an item included in an agreement concerning the service level;
upon detecting that the first value of the service level when the first system holds the specific data does not satisfy the fourth condition, determining whether a second value of the service level when the second system holds the specific data satisfies the fourth condition; and
upon detecting that the second value of the service level satisfies the fourth condition, storing data representing that the second system is a system in which the specific data is to be held.

10. The computer-readable, non-transitory medium as set forth in claim 6, the process further comprising:
upon detecting that the first condition is satisfied, transmitting the specific data to the second system; and
upon receiving an address of the specific data in the second system from the second system, changing an address of the specific data to the received address.

11. A method for determining a disposition destination of an application program, the method comprising:
obtaining, by a computer in a first system, data of a first cost that represents a communication cost for communication with a processing apparatus that is included in a second system and carries out a processing by an application program for data held in the first system;
calculating, by the computer, a second cost that represents a cost that occurs when the application program is disposed in the first system by using data of a charge for use of the application program and data of a cost required for maintenance and operation for an apparatus for carrying out a processing by the application program;
determining, by the computer, whether a first condition including a second condition concerning a relationship between the first cost and the second cost is satisfied; and
upon detecting that the first condition is satisfied, storing, by the computer, data representing that the first system is a system in which the application program is to be disposed.

12. A method for determining a disposition destination of data, the method comprising:
obtaining, by a computer in a first system, a first communication cost that represents a communication cost that occurs when a second processing apparatus in a second system carries out a processing for a specific data used in a processing by a first processing apparatus in the first system, and obtaining a first storage charge that represents a storage charge that occurs when the specific data is held by the first system to calculate a first charge that represents a charge for a service, which occurs when the specific data is held in the first system, by using the first communication cost and the first storage charge;
obtaining, by the computer, a transfer amount of data that is used in a processing by the first processing apparatus and used in a communication with the first processing apparatus among the specific data, from a transfer log storage unit storing transfer logs generated in response to data transfer, to calculate, by using the obtained transfer amount, a second communication cost that represents a communication cost presumed to occur when the first processing apparatus in the first system carries out a processing for the specific data when the specific data is held by the second system;
obtaining, by the computer, a second storage charge that represents a storage charge that occurs when the specific data is held by the second system to calculate, by using the second communication cost and the second storage charge, a second charge that represents a charge for a service, which occurs when the specific data is held by the second system;
determining, by the computer, whether a first condition including a second condition for a relationship between the first charge and the second charge is satisfied; and
upon detecting that the first condition is satisfied, storing, by the computer, data representing that the second system is a system in which the specific data is to be held.

13. An apparatus for determining a disposition destination of an application program, the apparatus comprising:
a memory;
a processor to execute a procedure, the procedure comprising:
obtaining data of a first cost that represents a communication cost for communication with a processing apparatus that is included in a second system and carries out a processing by an application program for data held in the first system;
calculating a second cost that represents a cost that occurs when the application program is disposed in the first system by using data of a charge for use of the application program and data of a cost required for maintenance and operation for an apparatus for carrying out a processing by the application program;
determining whether a first condition including a second condition concerning a relationship between the first cost and the second cost is satisfied; and
upon detecting that the first condition is satisfied, storing data representing that the first system is a system in which the application program is to be disposed, into the memory.

14. An apparatus for determining a disposition of data, the apparatus comprising:
a memory;
a processor to execute a procedure, the procedure comprising:
obtaining a first communication cost that represents a communication cost that occurs when a second processing apparatus in a second system carries out a processing for a specific data used in a processing by a first processing apparatus in the first system, and obtain a first storage charge that represents a storage charge that occurs when the specific data is held by the first system to calculate a first charge that represents a charge for a service, which occurs when the specific data is held in the first system, by using the first communication cost and the first storage charge;
obtaining a transfer amount of data that is used in a processing by the first processing apparatus and used in a communication with the first processing apparatus among the specific data, from a transfer log storage unit storing transfer logs generated in response to data transfer to calculate, by using the obtained transfer amount, a second communication cost that represents a communication cost presumed to occur when the first processing apparatus in the first system carries out a processing for the specific data when the specific data is held by the second system;
obtaining a second storage charge that represents a storage charge that occurs when the specific data is held by the second system to calculate, by using the second communication cost and the second storage charge, a second charge that represents a charge for a service, which occurs when the specific data is held by the second system;
determining whether a first condition including a second condition for a relationship between the first charge and the second charge is satisfied; and
upon detecting that the first condition is satisfied, storing data representing that the second system is a system in which the specific data is to be held, into the memory.
